(19) United States
(12) Patent Application Publication
(10) Pub. No.: US 2025/0376393 A1
(43) Pub. Date: Dec. 11, 2025

(54) SELF-REGENERATING GRAPHENE OXIDE-BASED ADSORBENTS FOR CONTAMINANT REMOVAL FROM AQUEOUS SYSTEMS

(71) Applicant: Northwestern University, Evanston, IL (US)

(72) Inventors: Kimberly A. Gray, Evanston, IL (US); Han Fu, Rosemead, CA (US)

(21) Appl. No.: 19/228,048

(22) Filed: Jun. 4, 2025

Related U.S. Application Data
(60) Provisional application No. 63/656,138, filed on Jun. 5, 2024.

(51) Int. Cl. C02F 1/72; B01J 20/20; B01J 20/28; B01J 21/06; B01J 35/39; B01J 35/45; C02F 1/28; C02F 1/32; C02F 101/30; C02F 101/34; C02F 101/36; C02F 101/38; C02F 103/34

(52) U.S. Cl. CPC C02F 1/725; B01J 20/103; B01J 20/205; B01J 20/28004; B01J 20/28019; B01J 21/063; B01J 35/39; B01J 35/45; C02F 1/283; C02F 1/32; C02F 2101/308; C02F 2101/34; C02F 2101/36; C02F 2101/38; C02F 2101/40; C02F 2103/343; C02F 2305/023; C02F 2305/08; C02F 2305/10

(57) ABSTRACT

Adsorbents for the removal of organic compounds from aqueous solutions and methods of making and using the adsorbents are provided. The adsorbents comprise composite particles based on crumpled 3D graphene oxide (GO) in which a mixture of inorganic nanoparticles that are photocatalytically active for the degradation of adsorbed organic contaminants and volume-expanding nanoparticles are dispersed.

### CROSS-REFERENCE TO RELATED APPLICATION

The present application claims the priority benefit of U.S. Provisional Patent Application No. 63/656,138 filed on Jun. 5, 2024, the entire disclosure of which is incorporated by reference herein.

### BACKGROUND

The presence of active pharmaceutical ingredients (APIs) in wastewater effluents and natural aquatic systems threatens ecological and human health. While activated carbon-based adsorbents, such as granular activated carbon (GAC) and powdered activated carbon (PAC), are widely used for API removal, they exhibit certain deficiencies, including reduced performance due to the presence of natural organic macromolecules (NOMs) and high regeneration costs. There is growing demand for a robust, stable, and self-regenerative adsorbent designed for API removal in various environments.

An expanding pharmaceutical sector inadvertently releases a wide range of active APIs to natural water systems (Bexfield et al. 2019, Environ. Sci. Technol., 53, 2950-2960; Gao et al. 2019, Environ. Sci.: Processes Impacts, 21, 867-880; Wilkinson et al. 2022, Nanoscale, 8, 14587-14592). Conventional water and wastewater treatment technologies fail to prevent API emissions over the manufacturing, use, and disposal life-cycle. Once released, many APIs and their metabolites persist in water systems at detectable levels (ranging from nanograms to micrograms per liter) (Reis et al. 2019, Environ. Pollut., 250, 773-781; Meyer et al. 2019, Environ. Sci. Technol., 53, 12961-12973). Long-term exposure to API mixtures in water risks various (eco) toxicological effects, including endocrine-disruption, to aquatic organisms and humans (Su et al. 2020, Sci. Total Environ., 720, 137652; Chafi et al. 2022, Chemosphere, 287, 132202; Gouveia et al. 2022, Sci. Total Environ., 853, 158559). Furthermore, exposure of APIs to the natural microbial community may promote the evolution of antibiotic-resistant bacteria and genetic material, contributing to the emergence of “superbugs” or pathogens that cannot be effectively treated with antibiotics (Kairigo et al. 2020, Sci. Total Environ., 720, 137580; Chaturvedi et al. 2021, Environ. Res., 194, 110664).

The growing concern surrounding the presence of APIs in water systems motivates the development of innovative technologies for API control. Studies have shown that granular activated carbon (GAC), a commonly used adsorbent, can effectively remove APIs in both batch reactors and continuous fixed-bed columns (Jaria et al. 2019, Sci. Total Environ., 653, 393-400; Delgado et al. 2019, J. Environ. Manage., 236, 301-308; Tang et al. 2020, Sci. Total Environ., 749, 141611; Köpping et al. 2020, Water Res. X, 9, 100057). However, GAC has several well-recognized limitations: 1.) GAC is non-selective, and its performance can be significantly compromised when target chemicals co-exist with non-target materials, such as natural organic macromolecules (NOMs) and phosphate ions, in complex water environments (Quinlivan et al. 2005, Water Res., 39, 1663-1673; Jaria et al. 2019, Sci. Total Environ., 653, 393-400); 2.) GAC exhibits sluggish adsorption kinetics (Kennedy et al. 2015, Water Res., 68, 238-248; Putra et al. 2009, Water Res., 43 (9), 2419-2430); 3.) GAC can quickly reach saturation, and regeneration is costly (Margot et al. 2013, Sci. Total Environ., 461-462, 480-498).

Considering the high cost of traditional GAC regeneration, light-driven regeneration has been proposed as an alternative. This approach involves decorating activated carbon with nano-sized photocatalysts, like titanium dioxide (TiO₂), or creating photocatalyst-carbon nanocomposites (Yap and Lim 2012, Water Research, 46 (9), 3054-3064; Zoghi and Allahyari 2022, Solar Energy, 237, 320-332; Zhu et al. 2021, Environmental Technology, 36 (24), 3094-3102; Xing et al. 2023, Journal of Environmental Management, 343, 118210). Under light illumination, the photocatalyst degrades adsorbed contaminants thereby regenerating the statured adsorption sites on the adsorbent. However, studies reveal that this method has significant limitations. For instance, light-driven regeneration on traditional activated carbon has proven to be inefficient, with one study showing that only 70% of the original adsorption capacity could be restored after 8 hours of illumination (Yap and Lim, 2012). Additionally, while some photocatalyst-carbon nanocomposites show promise, their success is primarily in removing dyes or hydrocarbons in batch experiments using ultrapure water (Zoghi and Allahyari, 2022; Zhu et al., 2021; Xing et al., 2023).

These limitations highlight the pressing need for a robust, cost-effective, stable, and self-regenerating adsorbent tailored to the efficient removal of APIs in various applications, including water/wastewater treatment, hospital effluent control, source separation, and point-of-use or fit-for-purpose treatment systems.

### SUMMARY

Composite particles and methods for using the composite particles to remove organic compounds from water or aqueous solutions are provided.

The composite particles comprise: crumpled graphene oxide balls; photocatalytically active nanoparticles dispersed within the crumpled graphene oxide balls; and volume-expanding nanoparticles dispersed within the crumpled graphene oxide balls.

One method of removing one or more organic compounds from water or an aqueous solution using the composite particles includes the step of: contacting the composite particles with the water or aqueous solution, whereby the one or more organic compounds adsorb to the crumpled graphene oxide balls; and illuminating the photocatalytically active nanoparticles dispersed within the crumpled graphene oxide balls with radiation to generate reactive oxygen species that induce photodegradation of the one or more adsorbed organic compounds.

### BRIEF DESCRIPTION OF THE DRAWINGS

Illustrative embodiments of the invention will hereafter be described with reference to the accompanying drawings, wherein like numerals denote like elements.

FIG. 1. Schematic diagram of a column packed with graphene oxide-based adsorbents for the removal of pharmaceutical compounds from water.

FIG. 2. The schematic diagrams of two fixed-bed column designs: Design I (ex-situ S-MGC regeneration) and Design II (in-situ S-MGC regeneration).

FIGS. 3A-3B. (FIG. 3A) The adsorption performance of S-MGCs and CGB (dotted line) on MB, represented by the % GO normalized qₘ (mmol/g); (FIG. 3B) The photodegradation performance of S-MGCs, CGB, and TiO₂ (dotted line) expressed through the pseudo-first-reaction constant, k₁ (1/hr). Three S-MGCs with optimal TiO₂:SiO₂:GO ratios are highlighted in grey. The error bars represent the deviation from the average of duplicated experiments.

FIGS. 4A-4E. The SEM images of (FIG. 4A) CGB; (FIG. 4B) S-MGC (TO₂:SiO₂:GO 1:1:1); (FIG. 4C) S-MGC (TO₂:SiO₂:GO 2:0.25:1); (FIG. 4D) S-MGC (TO₂:SiO₂:GO 3:1:1); (FIG. 4E) average particle sizes for CGB and three S-MGCs (calculated based on 30 particles in the SEM images, error bars represent the standard deviations) Statistical significance (p<0.05) for values of three S-MGCs compared with CGB is shown by asterisks.

FIG. 5. Average particle sizes for CGB and various S-MGCs (calculated based on 30 particles in the SEM images, error bars represent the standard deviations).

FIGS. 6A-6D. (FIG. 6A) XPS, (FIG. 6B) FTIR, (FIG. 6C) Nitrogen adsorption-desorption curves with calculated specific surface areas (CGB, TiO₂, and SiO₂ are also listed for comparison), and (FIG. 6D) pore size distribution of S-MGCs.

FIGS. 7A-7C. (FIG. 7A) Comparison of capacity qₘ (mmol/g) of five APIs between GAC and CGB. The comparison of % carbon normalized qₘ (mmol/g) of CGB and three S-MGCs in (FIG. 7B) single-component system; (FIG. 7C) multiple-component system. The error bars represent the standard deviations of triplicate experiments.

FIGS. 8A-8B. % GO normalized Langmuir maximum adsorption capacity qₘ (mmol/g) of five APIs with CGB, and three S-MGCs under (FIG. 8A) single-API system; (FIG. 8B) multiple-API system. The error bars represent the standard deviations of triplicated experiments.

FIGS. 9A-9B. The adsorption performance of different adsorbents in a mixture of five APIs in Milli-Q water, DOC 2.5 mg/L, and DOC 5 mg/L (FIG. 9A) GAC and (FIG. 9B) CGB and three S-MGCs represented by, qₘ (mmol/g), (FIG. 9B) % carbon normalized qₘ (mmol/g). The error bars represent the deviations from the average of duplicated experiments.

FIGS. 10A-10E. The adsorption performance of various adsorbents in a mixture of five APIs in the artificial urine: (FIG. 10A) GAC qₘ (mmol/g), (FIG. 10B) CGB % carbon normalized qₘ (mmol/g), and (FIGS. 10C-10E) three S-MGCs % carbon normalized qₘ (mmol/g). The error bars represent the maximum and minimum values derived from the average of duplicated experiments.

FIGS. 11A-11B. (FIG. 11A) The adsorption of phosphate ions on various adsorbents phosphate (initial phosphate concentration 1500 ppm, 0.1 mg/mL adsorbent dose, pH 7.5); (FIG. 11B) The adsorption performance of GAC in Milli-Q water and artificial urine (without addition of phosphate ions).

FIGS. 12A-12F. (FIGS. 12A-12E) The photodegradation curves of a mixture of APIs (1 mg/L initial concentration per each API) with TiO₂ and three S-MGCs (1 mg/mL dose) under light illumination and calculated pseudo-first-order reaction constant k₁ (1/min); (FIG. 12F) ROS yields of TiO₂ and three S-MGCs. The error bars represent the standard deviations of the triplicated experiments.

FIGS. 13A-13F. The breakthrough curves and calculated equilibrium adsorption capacity qₑ of (FIGS. 13A-13B) different adsorbents; (FIGS. 13C-13D) S-MGC (TiO₂:SiO₂:GO ratio 2:0.25:1) in two different water environments; (FIGS. 13E-13F) S-MGC (TiO₂:SiO₂:GO ratio 2:0.25:1) during multiple cycles of use in two different designs.

FIGS. 14A-14F. The SEM images of S-MGC (TiO₂:SiO₂:GO ratio 2:0.25:1) (FIGS. 14A-14B) before fix-bed column experiment; (FIGS. 14C-14D) after 3 cycles of use in Design I; (FIGS. 14E-14F) after 3 cycles in Design II.

FIG. 15. Monitoring the decomposition of the aromatic structure and amide group in CBZ during S-MGC regenerations in Design II.

FIG. 16. Calibration standards of methylene blue at 665 nm.

FIG. 17. Table 4. Summary on the adsorption breakthrough data (the breakthrough time to and the equilibrium adsorption capacity of qₑ) for different fixed-bed designs, different adsorbents, different water environments and different adsorption cycles.

FIG. 18. Table 5. Calculated Langmuir-Hinshelwood (L-H) model constants (a) K_{L-H} and (b) k_{L-H} for TiO₂ and three S-MGCs.

### DETAILED DESCRIPTION

Provided are adsorbents for the removal of organic compounds, including APIs, from aqueous solutions and methods of making and using the adsorbents. The adsorbents are well-suited for use in the removal of organic contaminants across diverse water environments and are more effective at the removal of some contaminants than GACs. Applications for the adsorbents include, but are not limited to, the removal of organic contaminants from wastewaters from industrial manufacturing plants (e.g., effluents from pharmaceutical manufacturing plants) and from medical facilities (e.g., effluents from hospitals or clinics), bodily fluids (e.g., urine), and natural bodies of water, such as lakes, rivers, and oceans. Moreover, the adsorbents are self-regenerating upon exposure to light and, therefore, can be used in fixed-bed columns at small, distributed scales for API and other contaminant removal.

The adsorbents are based on crumpled graphene oxide (GO), which is GO having a crumpled paper ball like structure with deep folds and wrinkles, referred to herein as crumpled graphene oxide balls. The GO in the adsorbents exhibits strong adsorptive affinity for organic compounds, including APIs. A mixture of inorganic particles that are photocatalytically active for the degradation of adsorbed contaminants and volume-expanding particles are dispersed within the wrinkles of the crumpled GO to form a composite material. Because the adsorbents are composed of a composite of different particulate materials (crumpled GO, photocatalytically active particles, and volume-expanding particles), they are referred to as “composite particles.” In some embodiments of the adsorbents, the photocatalytically active particles are TiO₂ nanoparticles and the volume-expanding particles are SiO₂ nanoparticles. These embodiments of the adsorbents are referred to herein as S-MGCs. However, as described below, other nanoparticles can be used in place of, or in combination with the TiO₂ and/or SiO₂ nanoparticles.

The photocatalytically active particles can be any particles that photodegrade contaminants adsorbed in the expanded crumpled GO balls when said particles are exposed to light. Thus, the material of the photocatalytically active particles can be selected based on the nature of the contaminants to be degraded. In some embodiments, the photocatalytically active particles degrade organic contaminants upon exposure to ultraviolet (UV) light (˜10 nm to ˜380 nm), visible light (˜380 nm to ˜750 nm), and/or infrared light (˜750 nm to ˜1 mm). The degradation of the organic contaminants is based on the generation of reactive oxygen species (ROS), such as hydroxyl radicals and/or peroxides, in water or aqueous solution when the photocatalytically active particles are exposed to the light. The ROS induce the degradation of the adsorbed organic compounds. The degradation of the adsorbed contaminants allows the products of the degradation to be removed from the adsorbents, so that the adsorbents can be regenerated and reused. The photocatalytically active particles are characterized by nanoscale dimensions and are referred to herein as “nanoparticles.” For the purposes of this disclosure a nanoparticle is a particle having a largest cross-sectional dimension (e.g., diameter or length) of less than 1000 nm.

In some embodiments, the photocatalytically active nanoparticles are inorganic nanoparticles comprising or consisting of metal oxide nanoparticles, such as titanium oxide or zinc oxide nanoparticles, and/or carbon nitride nanoparticles. In addition to possessing the ability to photodegrade organic molecules, the photocatalytically active nanoparticles are desirably characterized by the ability to resist aggregation to an extent that would significantly impair the functioning of the adsorbents.

The volume-expanding particles serve as internal spacers in the crumpled GO balls, disrupting internal GO stacking and increasing the adsorptive surface area of GO for contaminant adsorption. The volume-expanding particles expand the internal volume of the crumpled GO and result in folds that are shallower and more loosely packed, relative to crumpled GO that does not include the volume-expanding particles. While the photocatalytically active particles also may play a role in the expansion of the crumpled GO, that is not their primary function and they are less effective at expanding the internal volume than the volume-expanding particles, which are not photocatalytically active for the degradation of the contaminants. Like the photocatalytically active particles, the volume-expanding particles are characterized by nanoscale dimensions and are referred to herein as “nanoparticles.”

In some embodiments, the volume expanding nanoparticles are inorganic nanoparticles comprising or consisting of inorganic oxide nanoparticles, such as silicon dioxide nanoparticles. However, other inorganic nanoparticles, such as metal nitride and/or carbide nanoparticles, can be used in place of or in combination with one or more inorganic oxides. Like the photocatalytically active nanoparticles, the volume-expanding nanoparticles are desirably characterized by the ability to resist aggregation to an extent that would prevent them from becoming distributed in the internal volume (e.g., in folds) of the crumpled reduced graphene oxide.

The adsorbent composite particles that are comprised of the crumpled graphene oxide balls and the photocatalytically active and volume-expanding nanoparticles dispersed therein, typically have an average particle size in the range from 1 μm to 5 μm. This includes embodiments in which the composite particles have an average particle size in the range from 1 μm to 3 μm. However, composite particles having average particle sizes outside of these ranges can be used. Although both the photocatalytically active nanoparticles and volume-expanding nanoparticles contribute to the overall size of the adsorbent composite particles, the photocatalytically active nanoparticles and volume-expanding nanoparticles are very small, typically having an average size of 50 nm or less. By way of illustration, in some embodiments, the photocatalytically active nanoparticles and volume-expanding nanoparticles are nanoparticles having an average size in the range from 5 nm to 50 nm. This includes embodiments in which the volume-expanding nanoparticles have an average size in the range from 10 nm to 40 nm.

The relative amounts of crumpled graphene and particulate matter in the adsorbent composite particles can be tailored to the requirements of their intended application. Generally, the concentration of the photocatalytically active nanoparticles (including, for example, TiO₂) is desirably low enough to avoid, or to minimize, the formation of aggregates (clusters) of said nanoparticles on the outer surface of the crumpled graphene oxide balls, but high enough to efficiently activate the photodegradation of the contaminants. By way of illustration, in some embodiments, the photocatalytically active nanoparticle (e.g, TiO₂): crumpled graphene oxide ball mass ratio is 1:1 or higher. This includes embodiments in which the photocatalytically active nanoparticle (e.g, TiO₂): crumpled graphene oxide ball mass ratio is no greater than 5:1. The concentration of volume-expanding nanoparticles (including, for example, SiO₂) is desirably low enough to avoid, or to minimize, the formation of aggregates (clusters) of said nanoparticles on the outer surface of the crumpled graphene oxide balls. By way of illustration, in some embodiments, the volume-expanding nanoparticle (e.g, SiO₂): crumpled graphene oxide ball mass ratio is 2:1 or lower, including embodiments in which the volume-expanding nanoparticle: crumpled graphene oxide ball mass ratio is no greater than 1:1.

The mass ratios of the crumpled graphene oxide, photocatalytically active nanoparticles, and the volume-expanding nanoparticles can be tailored to increase or maximize contaminant adsorption or to increase or maximize contaminant degradation and adsorbent regeneration, depending on the requirements of a given application, whereby a higher content of the photocatalytically active nanoparticles relative to the volume-expanding nanoparticles and/or the crumpled graphene generally corresponds to a higher degree of contaminant degradation, and a lower content of the photocatalytically active nanoparticles relative to the volume-expanding nanoparticles and/or the crumpled graphene generally corresponds to a higher degree of contaminant adsorption. This is illustrated in the Example, where TiO₂:SiO₂:crumpled graphene oxide ball mass ratios 1:1:1 and 2:0.25:1 achieved different balances between contaminant degradation and adsorption. In addition, if alternative photocatalytically active nanoparticles and volume-expanding nanoparticles are used, adjustments to the component ratios may be desirable due to differences in their chemical and physical properties. For instance, photocatalytically active nanoparticles having comparable photoactivity for the degradation of contaminants (e.g. the illustrative APIs in the Example) as TiO₂ in aqueous environments could be used with similar loadings/mass ratios, whereas the mass loadings/mass ratios of less or more photocatalytically active nanoparticles may need to be adjusted upward or downward for optimal results. Similarly, volume-expanding nanoparticles with particle sizes and aggregate sizes resembling those of SiO₂ in aqueous environments could be used with similar loadings/mass ratios, whereas the mass loadings/mass ratios of smaller or larger volume-expanding nanoparticles may need to be adjusted upward or downward for optimal results. These adjustments can be made to ensure that the tailored component mass ratios effectively meet the requirements of the intended application.

The crumpled GO balls with the photocatalytically active nanoparticles and the volume-expanding nanoparticles dispersed therein can be made using spray drying techniques, as illustrated in the Example.

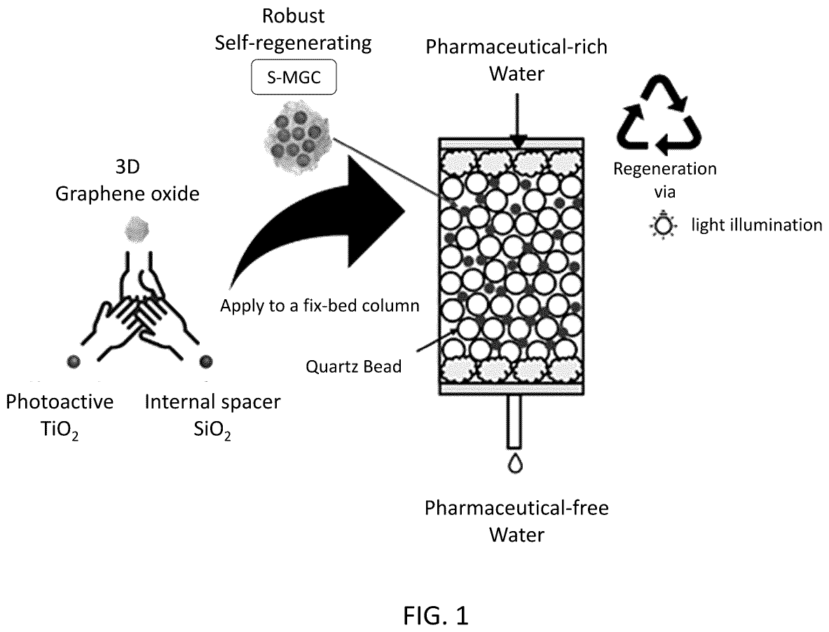

The use of the adsorbent composite particles to remove contaminants is illustrated schematically in FIG. 1. In this embodiment of the method, the photocatalytically active nanoparticles are TiO₂ nanoparticles, the volume-expanding nanoparticles that act as internal spacers are SiO₂ nanoparticles, and the contaminants being removed are various APIs. In the methods, the adsorbents are used to remove one or more organic compounds from water or an aqueous solution by contacting the adsorbent composite particles with water or an aqueous solution containing the one or more organic compounds and allowing the one or more organic compounds to adsorb to the crumpled graphene oxide. As shown in the figure, this may be accomplished by packing a column with the composite particles and running the water or aqueous solution through the column. The adsorbent composite particles and the adsorbed contaminants are then illuminated with light (radiation) that induces the photocatalytically active nanoparticles to photodegrade the organic compounds via the generation of ROSs, thereby regenerating the adsorbent composite particles. A xenon arc lamp is one example of a suitable light source.

The regenerated adsorbents can be reused in multiple (two or more) cycles. The adsorbents can be rinsed with water or an aqueous solution between cycles to remove the degradation products. When the adsorbent composite particles are contained within a column, it is desirable for the column to be transparent to the light used to activate the photocatalytically active nanoparticles, thereby enabling the regeneration of the adsorbent composite particles in situ.

The adsorption of the organic compounds on the crumpled graphene oxide may occur via one or more mechanisms. One mechanism is π-π electron-donor-acceptor interactions, which occur between the electron-rich/electron-deficient regions and polar functional groups of polyaromatic organic contaminants with the GO surface. Additional mechanisms, such as hydrogen bonding between hydrogen atoms and electronegative atoms and hydrophobic interactions between nonpolar molecules in water, may also contribute to the removal of organic compounds. Thus, in some embodiments of methods of using the adsorbents, the organic compounds being removed include one or more atomic rings, one or more electron-donating and/or withdrawing substitutions, and/or a hydrophobic nature.

Illustrative examples of APIs that can be adsorbed and degraded using the adsorbents described herein include sulfamethoxazole (SMZ), carbamazepine (CBZ), ketoprofen (KET), valsartan (VAL), and diclofenac (DIC). Other non-limiting examples of organic molecules that can be adsorbed and degraded include emerging water contaminants, which comprise personal care products, cosmetics, pesticides, pharmaceuticals such as sulfonamides (e.g., benzene sulfanilamide, sulfanilamide, homosulfamine, 4-amino-N-phenyl-benzene sulfonamide, sulfapyridine, sulfadiazine, sulfadimethoxine, sulfadoxine, sulfamethoxazole, and 4-nitro-sulfamethoxazole) and industrial chemicals, such as caffeine, sucralose, bisphenols, metolachlor, and oxybenzone. The contaminants being removed from the water or aqueous solution may be present as a single component or may be present as a mixture of two or more contaminants, and/or a mixture of organic contaminants and other organic molecules.

The concentration of the organic contaminants, such as APIs, in the water or aqueous solution will depend on the source of the water or aqueous solution. By way of illustration only, the water or aqueous solution may have a concentration of one or more organic contaminants in the range from 10 μg/L to 100 mg/L. This includes embodiments in which the water or aqueous solution has a concentration of one or more organic contaminants in the range from 50 μg/L to 50 mg/L. However, water and aqueous solutions having higher or lower concentrations of organic contaminants can be used.

As illustrated in the Example below, adsorbent composite particles of the types described and claimed herein can achieve high levels of organic contaminant removal. For example, equilibrium adsorption capacities (as defined in the Example) of 60 mg/g or greater, 70 mg/g or greater, or 100 mg/g or greater can be achieved. This includes equilibrium adsorption capacities in the range from 60 mg/g to 100 mg/g.

### EXAMPLE

This Example illustrates the synthesis of a self-generating metal oxide nano-composite (S-MGC) containing titanium dioxide (TiO₂) and silicon dioxide (SiO₂) combined with 3D crumpled graphene oxide (GO) to adsorb APIs and undergo regeneration via light illumination. An optimal TiO₂:SiO₂:GO composition of S-MGC was determined through experiments using a model contaminant, methylene blue. The physical and chemical properties of S-MGCs were characterized, and their adsorption and photodegradation capabilities were studied using five model APIs, including sulfamethoxazole, carbamazepine, ketoprofen, valsartan, and diclofenac, both in single-component and multi-component mixtures. In the absence of TiO₂/SiO₂, 3D crumpled graphene oxide (CGB) displayed better adsorption performance compared to GAC, and the inclusion of S-MGCs further improved GAC's adsorption capacity. This performance remained consistent in two complex water environments: aqueous solutions at varying NOM levels and artificial urine. TiO₂ supported on the GO surface exhibited similar photocatalytic activity to suspended TiO₂. In a continuous fixed-bed column test, S-MGCs demonstrated robust API adsorption performance that was maintained in the presence of NOM or urine and can be regenerated through three cycles of adsorption and light illumination.

To identify the optimal TiO₂:SiO₂:GO composition for S-MGCs, methylene blue (MB) was employed as a model organic contaminant and then the three best-performing S-MGCs were selected based on their adsorption and photodegradation behavior. The physical and chemical properties of the selected S-MGCs were characterized using scanning electron microscopy (SEM), X-ray photoelectron spectroscopy (XPS), Fourier-transform infrared spectroscopy (FTIR), specific surface area analysis, and pore size analysis. The adsorption performance of selected S-MGCs was assessed using five model APIs commonly detected in various water systems: sulfamethoxazole (SMZ), carbamazepine (CBZ), ketoprofen (KET), valsartan (VAL), and diclofenac (DIC) in both single-component and multi-component mixtures. In addition to an ultrapure water environment, the adsorption and photodegradation performance of S-MGC, CGB, and GAC were assessed in two complex aqueous environments: an artificial urine media and various NOM levels. Given that 75% of APIs and their metabolites in municipal wastewater are excreted in urine (Clark et al. 2021, Water Res., 198, 117106), targeting API removal in a source separation scenario prior to mixing with other wastewater effluents holds significant promise. Finally, adsorption and regeneration of S-MGCs were studied using a continuous flow fixed-bed column in comparison to activated carbon.

### Experimental Methods

### Materials and Reagents

Tables 1a and 1b provide an overview of the chemical structures and properties of methylene blue along with the active pharmaceutical ingredients (APIs) studied in this example. Additional information about other chemicals and reagents used in the experiments can be found in the Additional Experimental Details, below.

TABLE 1a

| | | Molec- | Polar | | |
|---|---|---|---|---|---|
| Chemical | | ular | Surface | H | H |
| Name | Supplier | Mass | Area | Donor | Acceptor |
| Methylene | Merck & Co. | 319.85 | 43.9 | 2 | 3 |
| blue | Inc. ≥99% | | | | |
| Sulfameth- | Dot | 253.28 | 103.8 | 2 | 8 |
| oxazole | Scientific >98% | | | | |
| Carbamaz- | Sigma- | 236.27 | 46.33 | 1 | 2 |
| epine | Aldrich >98% | | | | |
| Ketoprofen | Sigma- | 254.29 | 57.2 | 1 | 6 |
| | Aldrich ≥98% | | | | |
| Valsartan | TCI >98% | 435.52 | 108.76 | 0 | 11 |
| Diclofenac | Sigma- | 296.15 | 52.16 | 1 | 12 |
| | Aldrich >98% | | | | |

TABLE 1b

| | Aromatic | Aromatic | Atom | Bond | | |
|---|---|---|---|---|---|---|
| Chemical Name | Atom Count | Bond Count | Count | Count | pKa | LogKow |
| Methylene blue | 14 | 16 | 31 | 32 | 1.35 | 0.75 |
| Sulfamethoxazole | 11 | 11 | 28 | 29 | 0.25, 1.97, | 0.79 |
| | | | | | 6.16 | |
| Carbamazepine | 12 | 12 | 32 | 34 | 16.12 | 2.78 |
| Ketoprofen | 12 | 12 | 33 | 34 | 3.88 | 2.66 |
| Valsartan | 17 | 17 | 62 | 64 | 4.83 | 5.85 |
| Diclofenac | 12 | 12 | 30 | 31 | 4 | 3.97 |

The structures of the Chemicals in Tables 1a and 1b are shown below.

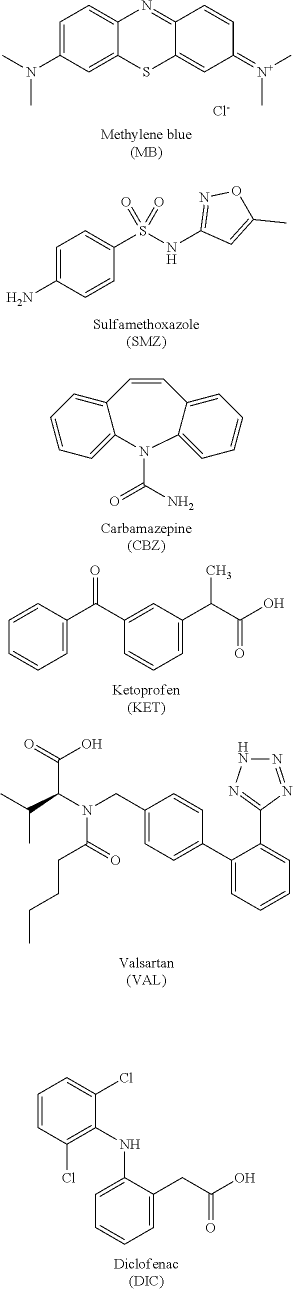

### S-MGC Synthesis and Characterization

The S-MGC synthesis and characterization methods are summarized in detail in the Additional Experimental Details, below.

Determination of the Optimized TiO₂:SiO₂:GO Ratio in S-MGC

Detailed information about the experimental procedures to determine optimized TiO₂:SiO₂:GO ratio in S-MGC is provided in the Additional Experimental Details, below.

### Adsorption and Photodegradation Experiment on APIs

Three S-MGCs (TiO₂:SiO₂:GO mass ratio 1:1:1, 2:0.25:1, and 3:1:1) were chosen for investigation; GAC and CGB were utilized for comparison. The initial API concentrations varied from 10-40 mg/L in the single-component experiments and 1-4 mg/L per API in the multiple-component experiment. The prepared solutions were dispensed into 50 mL Teflon-lined screw-top glass vials; the pH was adjusted to 7.5±0.1; the adsorbent (GAC, CGB, and different S-MGCs) was then added at a dosage of 0.1 mg/mL. All sample vials were kept shaking in the dark for 24 hours to reach equilibrium. In addition to Milli-Q water, the adsorption performance of S-MGCs in the multiple-component experiment was also studied in Milli-Q water with varied levels of NOM and artificial urine. Two NOM concentrations were prepared: 5 mg/L and 10 mg/L, which were equivalent to dissolved organic carbon (DOC) levels of 2.5 mg/L and 5 mg/L, respectively, and typical of the DOC range in surface waters. The artificial urine was prepared via the protocol developed by Sarigul et al. (Sarigul et al. 2019, A New Artificial Urine Protocol to Better Imitate Human Urine. Rep., 9) (the detailed formulation in Table 2).

TABLE 2
The artificial urine composition*.

| | Molarity (mM) | Quantity (g/100 mL) |
|---|---|---|
| Na₂SO₄ | 11.965 | 0.170 |
| C₅H₄N₄O₃ | 1.487 | 0.025 |
| Na₃C₆H₅O₇•2H₂O | 2.450 | 0.072 |
| C₄H₇N₃O | 7.791 | 0.088 |
| CH₄N₂O | 249.750 | 1.500 |
| KCl | 30.953 | 0.231 |
| NaCl | 30.053 | 0.176 |
| CaCl₂ | 1.663 | 0.019 |
| NH₄Cl | 23.667 | 0.127 |
| K₂C₂O₄•H₂O | 0.190 | 0.004 |
| MgSO4•7H₂O | 4.389 | 0.108 |
| NaH₂PO₄•2H₂O | 18.667 | 0.291 |
| Na₂HPO₄•2H₂O | 4.667 | 0.083 |

*Adapted from previous study: Sarigul et al., 2019.

The quantification of API concentrations was performed by HPLC-MS/MS (QExactive, Thermo-Fisher Scientific) using a C18 column (Thermo-scientific BDS Hypersil C18). The quantification of analytes was determined from calibration standards based on linear regression calculation. The detailed ionization mode, retention time, and the exact mass of the adduct are listed in Table 3. The Langmuir isotherm model was employed to fit the experimental data. Moreover, the Langmuir adsorption capacity qₘ, was normalized by the carbon weight percentage (% carbon) in the initial metal oxides: GO mixture to correct for the metal oxide presence (which does not contribute adsorptive surface area) and evaluate the performance of GO adsorption in the S-MGCs. The % carbon was quantified using an elemental analyzer (ECS 4010, Costech Analytical, Valencia, CA). The calculation for the % carbon normalized qₘ of the adsorbent is as follows:

$$\% c arbon normalized {q}_{m} = \frac{Adsorded MB [ mg ]}{A d s o rbent weight [ mg ] \times \% Carbon} = \frac{{q}_{m}}{\% Carbon}$$

TABLE 3
HPLC analytical data for 5 model APIs.

| Chemical | CAS | | Exact | Retention |
|---|---|---|---|---|
| Name | Number | Adduct | Mass | Time |
| Sulfamethoxazole | 723-46-6 | [M + H]+ | 253.28 | 5.3 |
| Carbamazepine | 298-46-4 | [M + H]+ | 236.27 | 6.3 |
| Ketoprofen | 22071-15-4 | [M + H]+ | 2254.29 | 6.8 |
| Valsartan | 137862-53-4 | [M + H]+ | 435.53 | 6.9 |
| Diclofenac | 15307-86-5 | [M + H]+ | 296.17 | 7.5 |

The API photodegradation experiments were conducted in a batch setup. A 50 mL API mixture solution (1 mg/L initial concentration per each API) was prepared in a 100 mL beaker and the pH of the solution was adjusted to 7.5±0.1. Ten mg catalyst (S-MGC or TiO₂ dose 0.2 mg/mL) was added, and the suspension was stirred at 300 rpm in the dark for 30 minutes to reach the adsorption equilibrium. After turning on the light at various time intervals (0, 10, 20, 30, 60, 90, and 120 minutes), the suspension was sampled using a syringe (BD 1 mL TB Syringe) and it was passed through a 0.2 μm polyvinylidene fluoride (PVDF) syringe filter (Cytiva Cat. #6779-1302). API concentrations were quantified using HPLC-MS/MS, similar to the adsorption experiment. To evaluate the photodegradation kinetics of S-MGC in a mixture of five APIs, two different models were utilized: a pseudo-first-order reaction model and the Langmuir-Hinshelwood (L-H) model. The linearized form of pseudo-first-order reaction is:

$${ln [ API ]}_{0} - {ln [ API ]}_{t} = k t$$

where [API]₀ and [API]ₜ are the initial API concentration and concentration at time t (mg/L), respectively. k is the pseudo-first-order reaction constant (1/min). The linearized form of L-H model is:

$$\frac{1}{{r}_{0}} = \frac{1}{{k}_{L - H} {K}_{L - H}} \times \frac{1}{{[ API ]}_{0}} + \frac{1}{{k}_{L - H}}$$

where r₀ is the initial photocatalytic degradation rate (determined via initial rate method (Du et al. 2009, React. Kinet. Catal. Lett., 97 (1), 83-90)), KL-His the L-H reaction constant (mg/(L min)), KL-His the L-H adsorption constant (L/mg), [API]₀ is the initial API concentration (mg/L).

### Reactive Oxygen Species (ROS) Measurement

ROS yields were quantified using the appropriate absorbance & fluorescence molecular probes summarized in the Additional Experimental Details, below.

### The Fixed-Bed Column Experiment Utilizing S-MGCs

The Rapid Small-Scale Column Test (RSSCT) scaling assumption was used, employing either proportional or constant diffusivity models to design the fixed-bed experiments. First, a blend of adsorbent with quartz beads as the filling material of the fixed-bed column was prepared. In a 50 mL Teflon-lined screw-top vial, 50 grams of quart beads (acid-washed, particle size≤106 μm, Sigma-Aldrich #G4649) and 50 mg adsorbent (S-MGCs, GAC or PAC) were added. While PAC is infrequently utilized in fixed-bed columns, its smaller particle sizes and differing pore characteristics offer valuable points of comparison. This mixture was blended on a rotating mixer (MASTERFLEX L/S Compact Drive) at a speed of 40 rpm overnight to ensure even distribution. Two best-performing S-MGCs (TiO₂:SiO₂:GO ratio 1:1:1 and 2:0.25:1) were chosen for the fixed-bed column test; GAC and PAC were used for comparison.

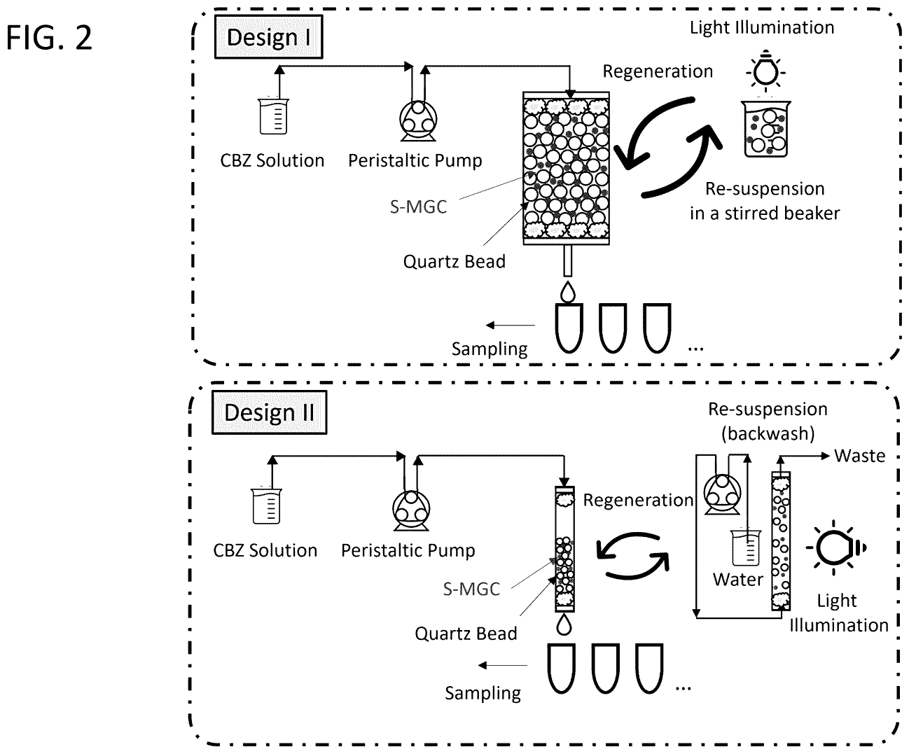

Two different fixed-bed column designs were set up. Schematic diagrams of these designs are presented in FIG. 2. In Design I, a UV quartz sleeve (Viquia QS-330) with an internal diameter of 2.0 cm and a height of 6 cm served as the column body. The column was oriented vertically, with both ends sealed using Neoprene Stoppers (with one open hole, Eisco Labs, No. CH0321G1H). From bottom to top, the column was filled with a Durapore PVDF membrane filter (0.1 μm, CAT #VVLP04700), a ball of glass wool (Fisherbrand™ Cat. NO. 22-456-885), the adsorbent blend (50 grams), and a glass wool ball. A peristaltic pump (Fisherbrand Cat #17-876-1) was utilized to provide a 0.6 mL/min feed pump. During the adsorption experiment, 50 mL Milli-Q water was initially fed into the column to saturate it. Subsequently, a CBZ solution (the model API with an initial concentration of 50 μg/L) was introduced. Water samples (500 μL per each sample vial) were continuously collected for 20 bed volumes. Each sample was then passed through a 0.2 μm PVDF syringe filter (Cytiva Cat. #6779-1302), and the CBZ concentrations were determined using the HPLC-MS/MS methodology. Another 50 mL of Milli-Q water was introduced into the column to remove any residual CBZ. The column was then disassembled, and the adsorbent blend was transferred to a 250 mL beaker and resuspended in 200 mL of Milli-Q water on a magnetic stirrer (stirring at 500 rpm with a magnetic stir bar). To regenerate the adsorbent, it was exposed to light illumination (1000 W ozone-free xenon arc lamp, model #6271) for 4 hours from the top of the beaker. Subsequently, the adsorbent was separated via centrifugation (Eppendorf Model 5810) at 9000 rpm for 15 minutes and then dried at 80° C. overnight. The adsorbent was blended on a rotating mixer overnight again and used for another cycle of the fixed-bed column experiment.

The distinction between the two column designs lies in the regeneration procedure. Unlike the “ex-situ” regeneration method in Design I, the inventors aimed to achieve “in-situ” regeneration in Design II, meaning that the adsorbent regeneration was carried out within the column itself, without the need for column disassembly, as required in Design I. For Design II, a different column body (Wilmad clear Fused-Quartz tubes, outer diameter 4.0 mm, Sigma part #Z566535-5EA) was utilized to ensure light illumination of the entire column during regeneration. The top and bottom ends were sealed with a 0.7 μm PVDF syringe filter (Cytiva Cat. #68251307). The column was filled from bottom to top with a glass wool ball (Fisherbrand™ Cat. NO. 22-456-885), the adsorbent blend (10 g), and another glass wool ball. During the adsorption experiment in Design II, 10 mL of Milli-Q water was initially introduced into the column to wet it. The water was supplied using a peristaltic pump with a feed speed of 0.6 mL/min. Subsequently, a CBZ solution (50 μg/L) was introduced. Water samples (500 μL per sample) were continuously collected for 21 bed volumes. Each sample was then passed through a 0.2 μm PVDF syringe filter, and the CBZ concentrations were determined as above. After the adsorption phase, another 10 mL of Milli-Q water was introduced into the column to remove any remaining CBZ. During the adsorbent regeneration step, the peristaltic pump first supplied Milli-Q water from the bottom of the column at a feed speed of 0.6 mL/min. Once a consistent water flow from the top of the column, light illumination was provided from the side of the column for 4 hours, using a 1000 W ozone-free xenon arc lamp (model #6271). The column was subsequently dried at 80° C. and used for another cycle of the adsorption experiment.

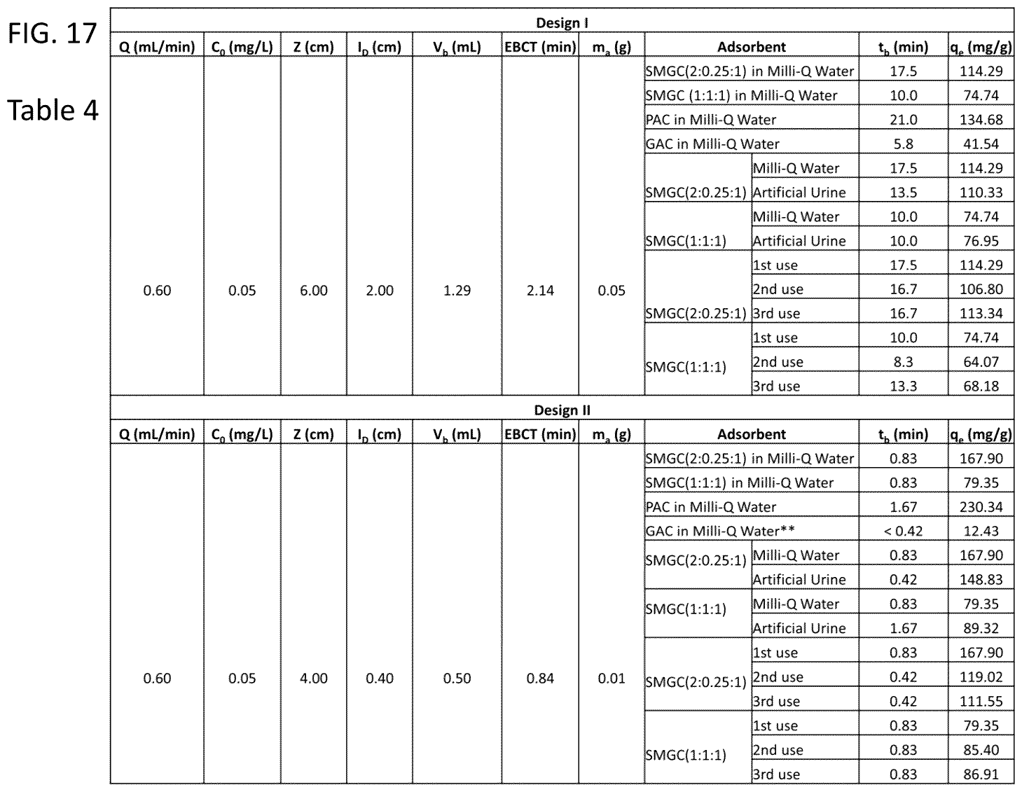

Absorbent performance in the fixed-bed column was evaluated on the equilibrium adsorption capacity of qₑ of the breakthrough curve, which was widely used in many previous studies (Bai et al. 2022, Chemosphere, 296, 134021; Antonelli et al. 2021, Ind. Eng. Chem. Res., 60, 4030-4040; Zhang et al. 2019, Chem. Eng. J., 370, 1262-1273). The equilibrium adsorption capacity qₑ can be calculated as:

$${q}_{e} = \frac{Q {\int }_{t = 0}^{t \vert Ct = Co} {C}_{t} dt}{{m}_{e}}$$

where Q is the CBZ volumetric flow rate (mL/min), Cₒ is the initial CBZ concentration (mg/L), Cₜ is the CBZ concentration taken at time t (sec), me is the mass of the adsorbent (g). The integral of the formula was calculated via OriginLab (OriginPro 2023bR1 version 10.0.5.157). The calculated qₑ, t_{b} (the breakthrough time at the point where C/Cₒ>0.05), and other parameters of two fix-bed column designs are summarized in Table 4, which is provided in FIG. 17.

### Results and Discussion

### Selection of Best S-MGC Based on MB Removal

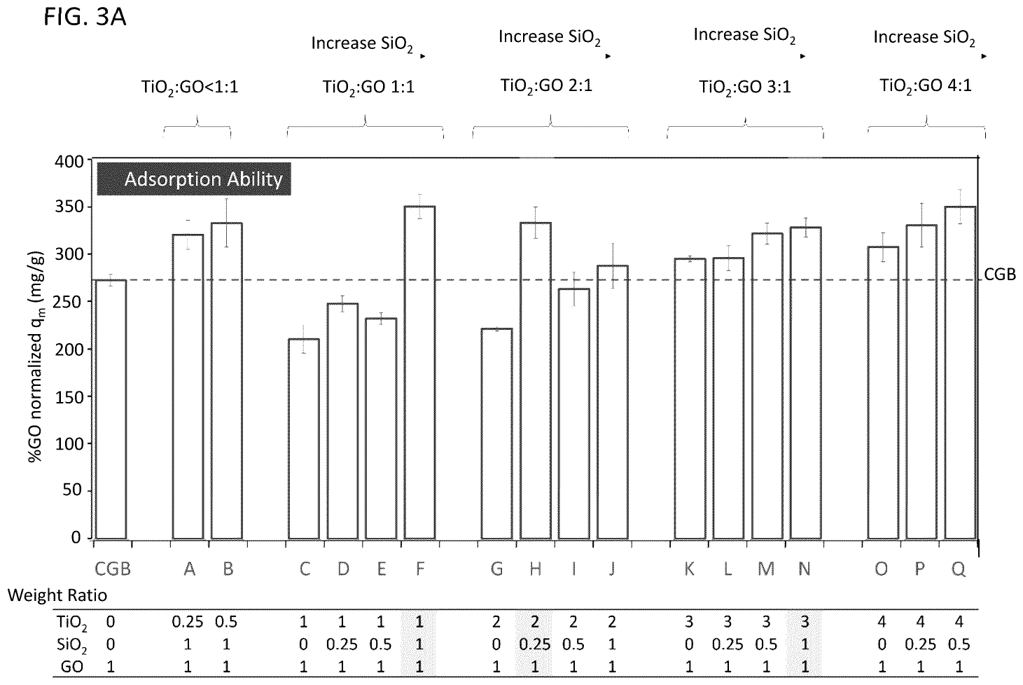

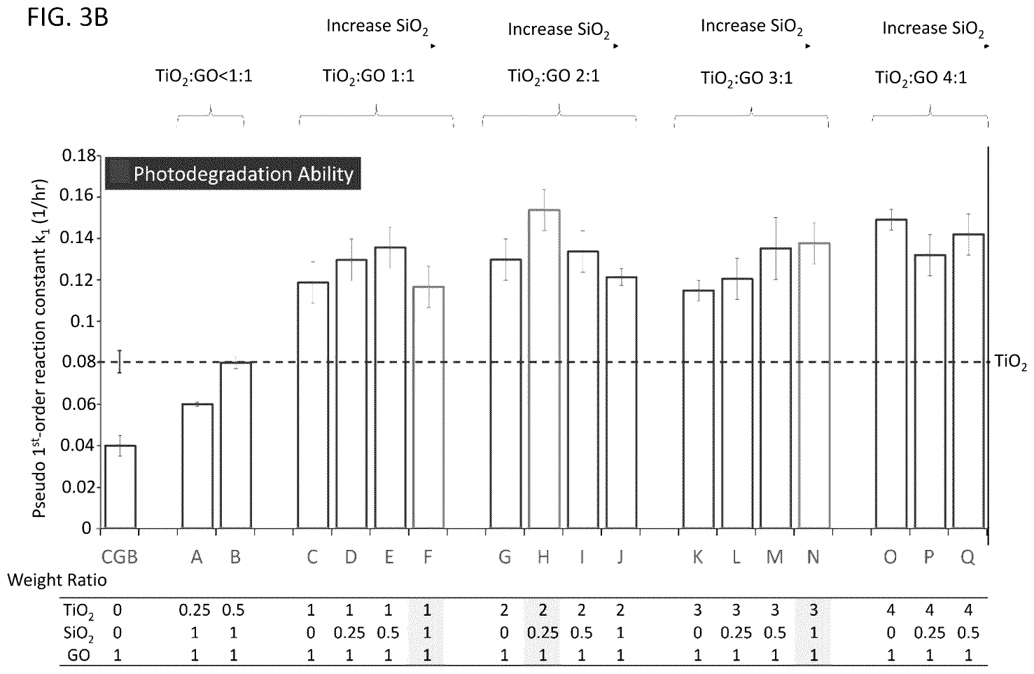

FIGS. 3A-3B present a comparison of adsorption and photodegradation of a variety of S-MGCs for MB removal. S-MGCs are classified into 6 different groups based on the TiO₂:CGB (GO only), sample A-B (TiO₂:GO below 1:1), sample C-F (TiO₂:GO=1:1), sample G-J (TiO₂:GO=2:1), sample K-N(TiO₂:GO=3:1) and sample O-Q (TiO₂:GO=4:1). Within each group, the SiO₂:GO ratio increased from 0.1:1 to 1:1 (SiO₂:GO ratio maintained at 1:1 in sample A and B). In comparing adsorption (% GO normalized qₘ in FIG. 3A and adsorption isotherms (not shown here; available in U.S. provisional application 63/656,138), most of S-MGCs showed enhanced adsorption performance relative to CGB (except samples C, D, E, G). In particular, the top S-MGC adsorbent (sample F, then sample A, B, H, N, and Q) showed 50-60% larger % GO normalized qₘ than CGB. The reduced performance of sample C, D, E, G suggests that at low TiO₂ content (TiO₂<2:1), especially where SiO₂ was absent or in low concentrations, TiO₂ failed to enhance S-MGC adsorption performance. Unfortunately, TiO₂ is a poor “internal spacer” due to its tendency to form large aggregates during S-MGC synthesis. In sample C, D, E, G, the aggregated TiO₂ even inhibited some of the active sites for MB adsorption. On the other hand, SiO₂ serves as an exceptional “internal spacer” because nano-SiO₂ aggregates to a lesser extent and smaller sizes during S-MGCs synthesis. Thus, the adsorption performance of S-MGCs improved, when SiO₂ content was increased (e.g. the best-performing sample A, B, F, H, N, and Q with the higher SiO₂:GO ratio of 1:1).

FIG. 3B illustrates the photodegradation performance, measured by the pseudo-first-order reaction constant k₁ of the various S-MGCs (detailed photodegradation curves provided in U.S. provisional application 63/656,138), and compared to the performance of TiO₂ (dot line). In general, the majority of S-MGCs exhibited similar photo-activities for degrading MB (the best-performing Sample H had 10-20% higher k₁ values than other S-MGCs) and demonstrably faster degradation kinetics compared to TiO₂ (50-85% larger k₁ values) or GO-only CGB (1 to 4 times larger k₁ value). However, there were two exceptions, Samples A and B, which contained smaller amounts of TiO₂ (TiO₂:GO ratio 0.25:1 and 0.5:1) and exhibited lower photoactivity compared to TiO₂ (5-10% lower k₁ value) and other S-MGCs (60-80% lower k₁ value). The weak performance of Samples A and B suggests that a minimum amount of TiO₂ (TiO₂:GO ratio≥1:1) was necessary to efficiently activate the photo reactivity of S-MGCs.

S-MGCs with the TiO₂:GO ratio of 4:1 were eliminated from further consideration because it was observed under SEM that some MO clusters were visible on the composite surface and were not encapsulated into S-MGCs. Sample A and Sample B (TiO₂:GO ratio<1:1) were excluded due to their low photoactivities (60-80% lower k₁ value than other S-MGCs).

Based on this comparison, three S-MGCs were selected for further investigation: Sample F, which exhibited the best adsorption performance; Sample H, which demonstrated the highest rate of photodegradation and second-best adsorption performance; and Sample N, which showed the third-best adsorption performance and relatively low material cost among all S-MGCs.

### S-MGC Characterization

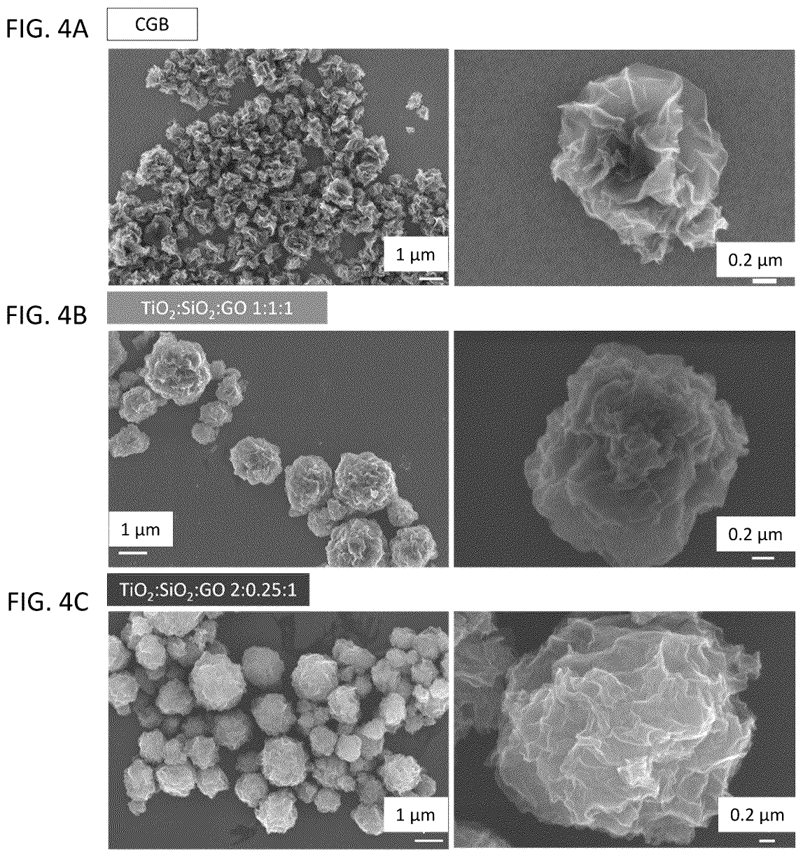

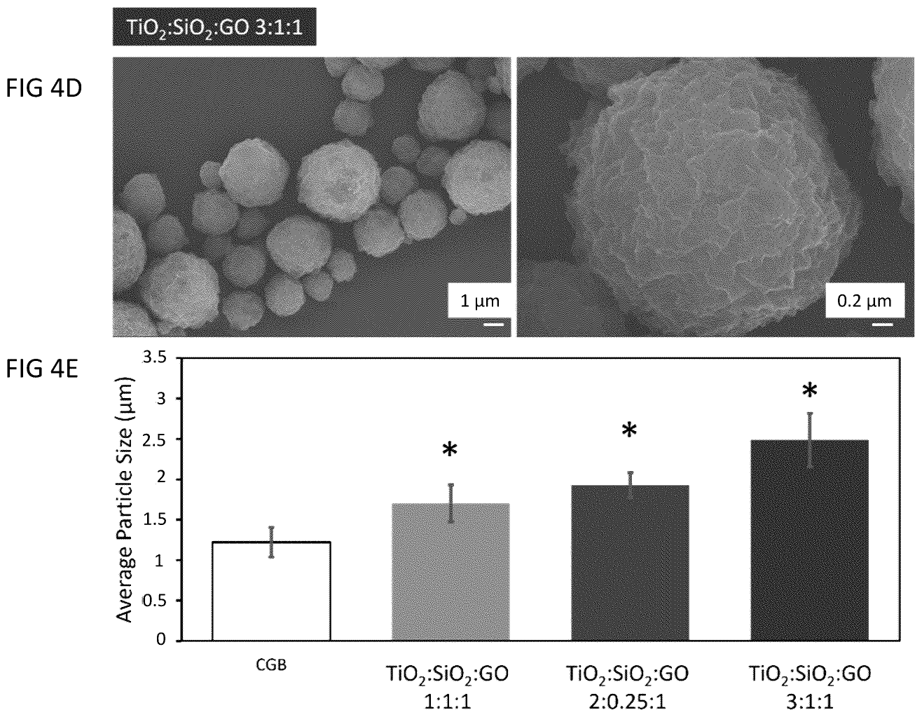

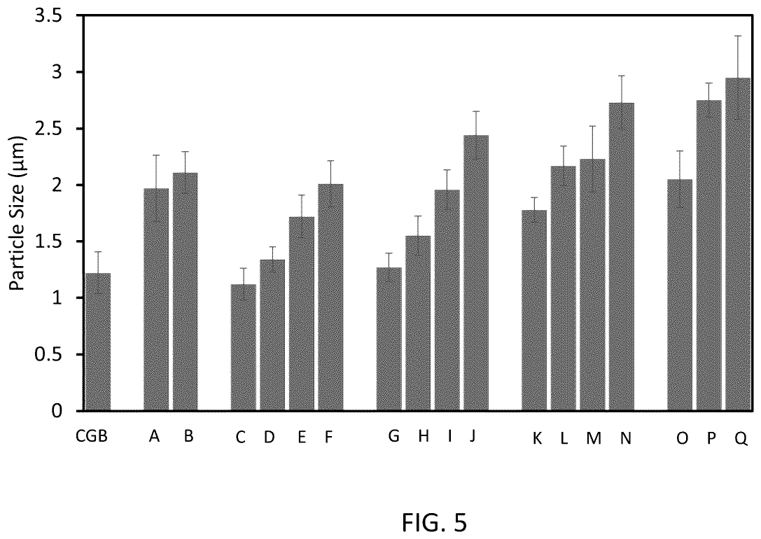

FIGS. 4A-4E present the SEM images of CGB (FIG. 4A) and three selected S-MGCs (FIGS. 4B-4D), along with their average particle sizes (FIG. 4E). The CGBs showed a non-planar, crumpled paper ball like structure with deep folds and wrinkles. The surface folds appeared less deep and tightly packed in S-MGCs in comparison to CGBs because the metal oxides expanded the internal space within CGBs. Without the incorporation of metal oxides, CGBs showed an average particle size of 1-1.2 μm (FIG. 4E). The photocatalyst TiO₂ has an average nominal particle size 15-40 nm, but in the water environment during S-MGC synthesis, TiO₂ aggregated simultaneously, resulting in an aggregate size of 700 nm. Meanwhile, the volume-expanding particle SiO₂ has an average nominal particle size of 10-20 nm and dispersed more evenly than TiO₂ in water during S-MGC synthesis (aggregate size of 300 nm), indicating SiO₂ serves as a good volume-expanding particle. As the two metal oxides were added into CGB and their proportions increased (specifically SiO₂), S-MGCs demonstrated larger particle sizes attributed to the expanded internal space (FIG. 5). Specifically, as FIG. 4E shows, the three S-MGCs exhibit particle sizes 1.4 to 2 times larger than CGBs. EDS line scans of three representative S-MGCs (available in U.S. provisional application 63/656,138, showed that both TiO₂ and SiO₂ were distributed within the 3D crumpled GO of the nanocomposite. For S-MGCs with TiO₂:SiO₂:GO ratios 1:1:1 and 3:1:1, some higher intensity peaks of Si were visible along the line scan of S-MGC, which suggested a slight level of aggregation of SiO₂ at this higher loading during S-MGC synthesis and in comparison to the 2.0:0.25:1 loading.

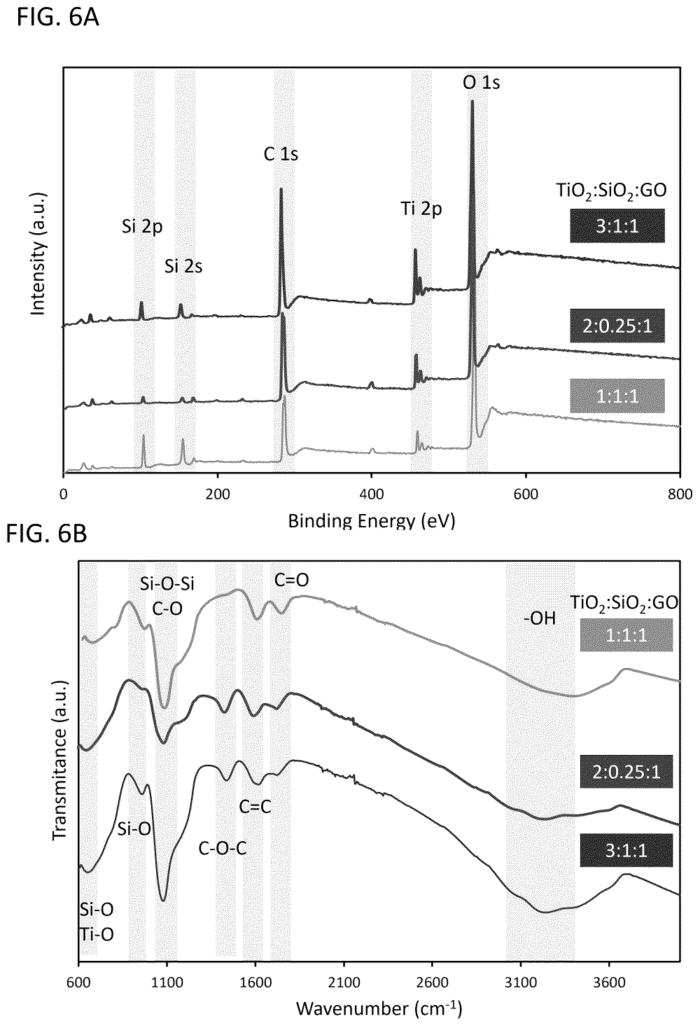

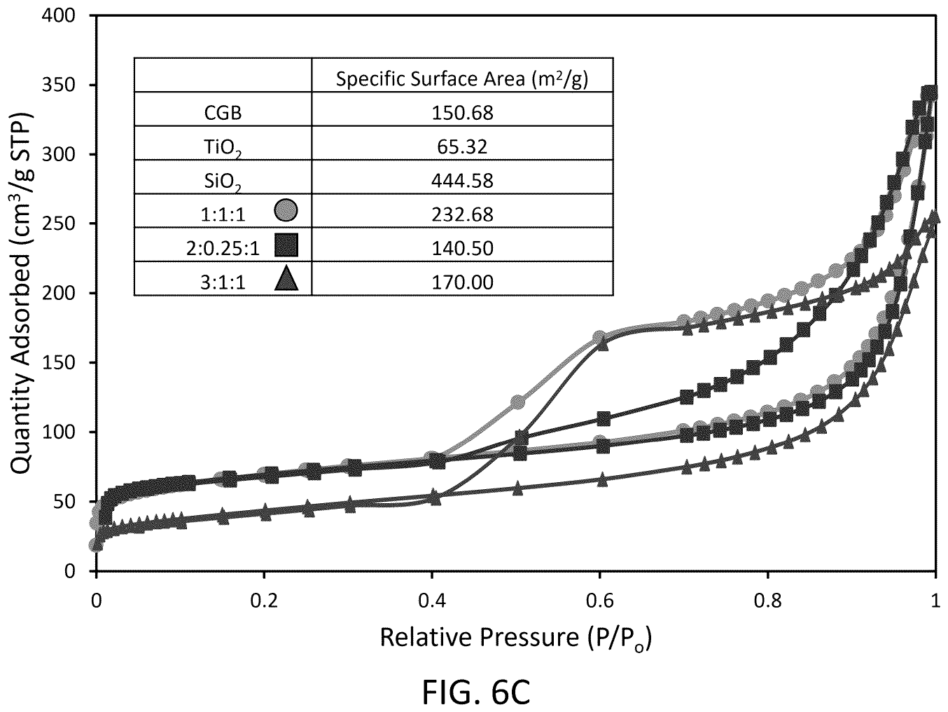

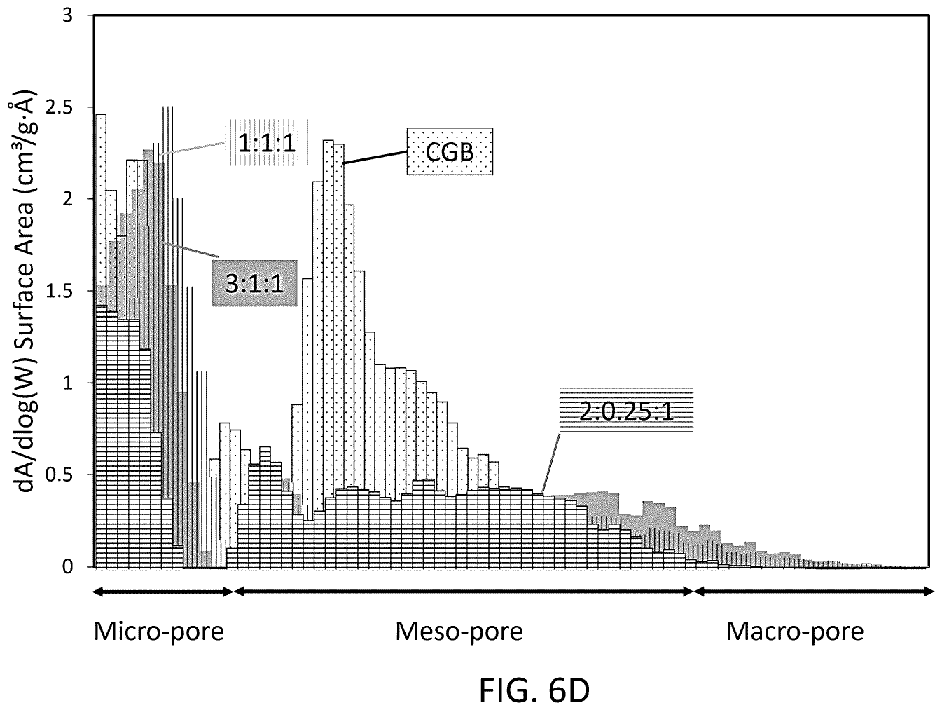

In FIG. 6A, the XPS spectra revealed that oxygen, carbon, titanium, and silicon are major components of S-MGCs. Si peaks were relatively weak in the TiO₂:SiO₂:GO ratio 2:0.25:1 and became more prominent at the other two ratios as the SiO₂ content increased. The FTIR results, as shown in FIG. 6B, corroborate the chemical properties revealed in the XPS data. Peaks corresponding to C—O—C, —OH, and C═O bonds were observed, along with Si—O and Ti—O peaks. FIG. 6C illustrates the nitrogen adsorption-desorption isotherms for all three representative S-MGCs. These isotherms exhibited the IUPAC Type IV curve, indicating the micro/mesoporous structure of S-MGCs. FIG. 6C also summarizes the specific surface areas (SSAs) of SiO₂, TiO₂, CGB, and the three S-MGCs. The SSAs of S-MGCs were influenced by the properties of the metal oxides in the composites. Since SiO₂ had the highest SSAs among all the components, the S-MGCs with a large SiO₂ weight portion in the composite had large SSAs. For example, S-MGC with TiO₂:SiO₂:GO ratio 1:1:1 had a larger SSA than S-MGC with TiO₂:SiO₂:GO ratio 2:0.25:1 and 3:1:1. In the pore size distribution analysis (FIG. 6D), a micro/mesopore-dominating structure of S-MGCs was further confirmed. Contrasting with predominantly microporous/mesoporous CGB (as indicated by hollow bars in FIG. 6D), S-MGCs exhibited a combination of micropores, mesopores, and even macropores. The presence of macropores in S-MGCs indicates that metal oxides can expand the internal space of CGBs, providing more adsorptive surface for API adsorption. Overall, the characterization results suggest that both metal oxides function as physical spacers in S-MGCs, without forming new chemical bonds with GO or altering its fundamental properties.

### Adsorption Performance of S-MGCs

The adsorption kinetics of one S-MGC (TiO₂:SiO₂:GO 2:0.25:1), CGB, and GAC were investigated in a mixture of APIs (graphs available in U.S. provisional application 63/656,138). All three adsorbents reached adsorption equilibrium after 24 hours. In contrast to the slow adsorption kinetics of GAC, both CGB and S-MGC exhibited rapid adsorption for API removal, requiring only 15 minutes to reach equilibrium.

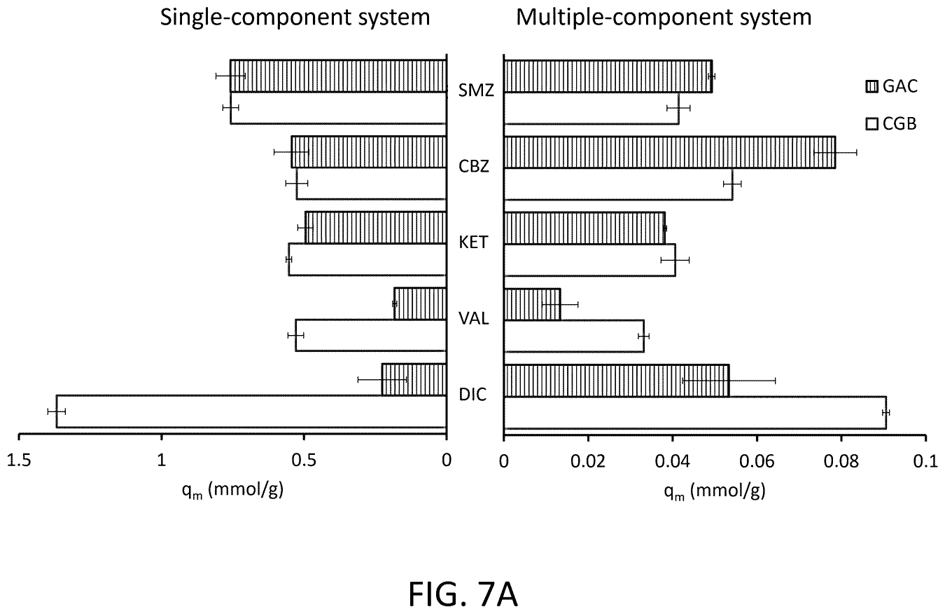

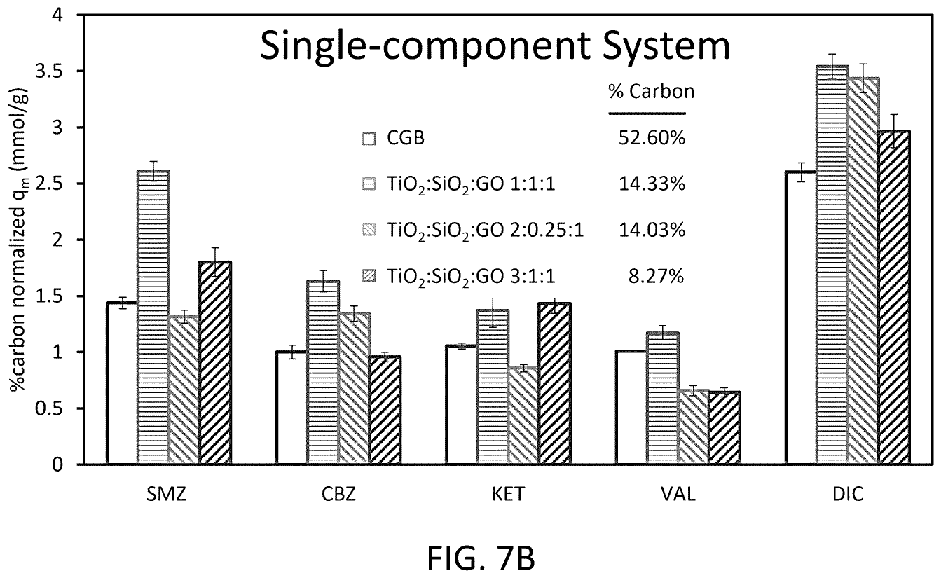

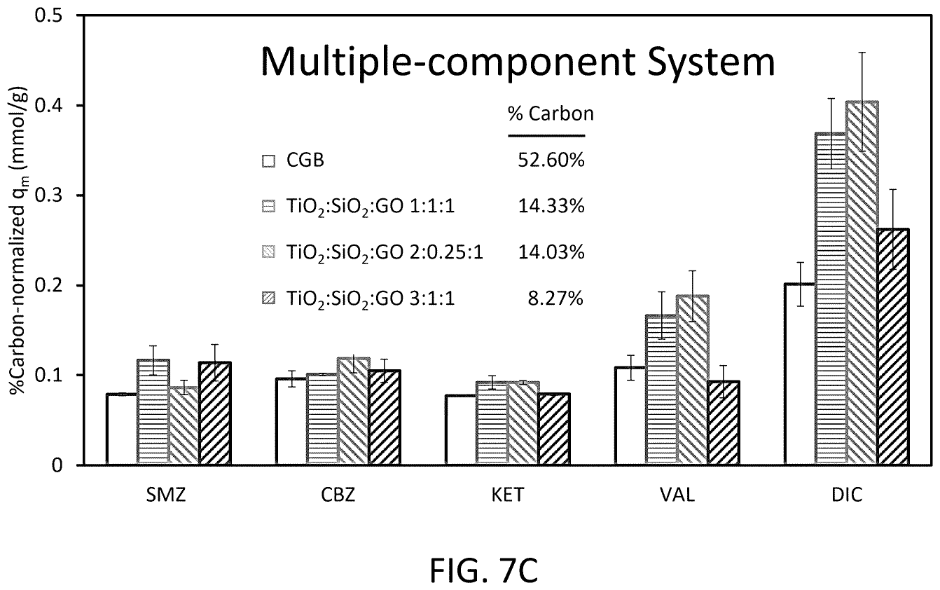

FIGS. 7A-7C illustrate the adsorption performance of GAC, CGB, and S-MGCs in the single-component and multiple-component API systems (detailed adsorption isotherms available in U.S. provisional application 63/656,138). FIG. 7A compares the qₘ between CGB and GAC. In the single-component system, CGB showed similar adsorption performance as GAC for SMZ, CBZ, and KET (10% deviation in qₘ), and outperformed GAC with DIC (5.1 times larger qₘ) and VAL (1.8 larger qₘ). In the multiple component system, CGB and GAC had similar adsorption capacities for SMZ and KET (10% deviation in qₘ), GAC showed better adsorption of CBZ (30% enhancement on qₘ) than CGB. In both single (70% greater qₘ) and multiple component (150% greater qₘ) systems, CGB adsorbed DIC to a far greater extent than GAC.

The adsorption performance of CGB and S-MGC were compared, as illustrated in FIGS. 7B-7C. Given the negligible adsorption of TiO₂ and SiO₂ in a mixture of APIs, only the GO surface served as the active adsorptive surface in the nanocomposite. Therefore, to account for the adsorptive dominance of GO, the adsorption was evaluated by various formulations using a % carbon normalized qₘ to reflect that only CGB contained carbon.

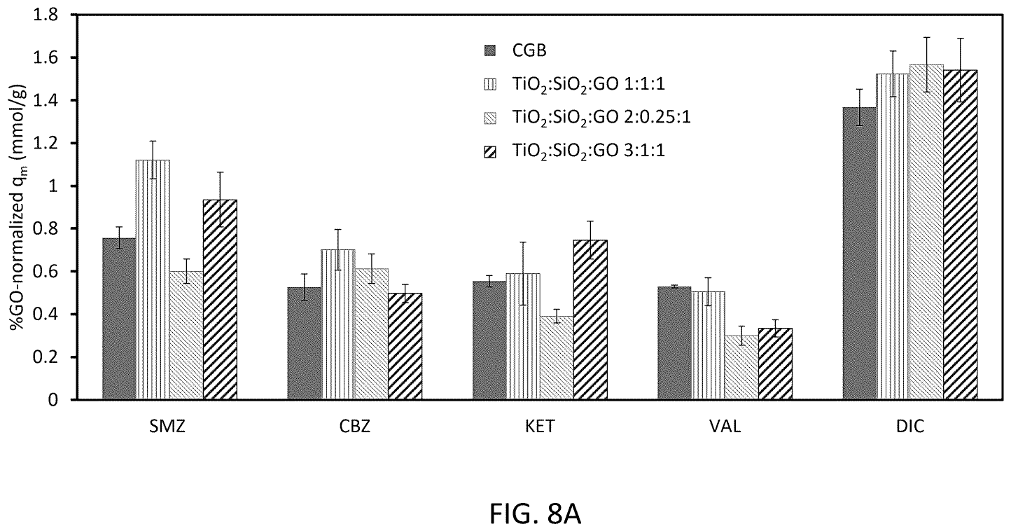

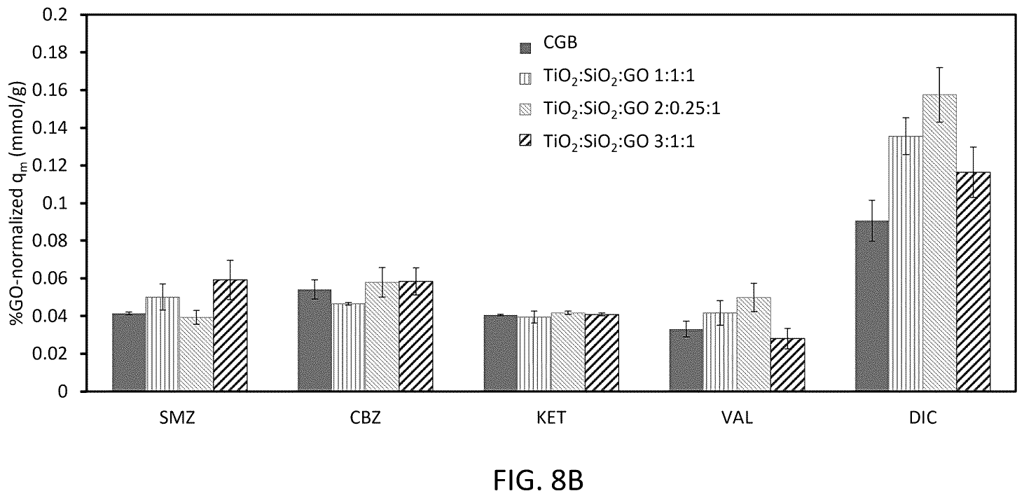

In FIG. 7B (single-component system), the best-performing S-MGC (TiO₂:SiO₂:GO ratio of 1:1:1) exhibited improvements in the range of 15-80% over CGB's performance. In the multiple-component system (as shown in FIG. 7C), S-MGCs surpassed CGB with some specific APIs; for example, the best-performing S-MGC (TiO₂:SiO₂:GO ratio 2:0.25:1) removed 75% more VAL and provided a 100% increase in DIC in the multiple-component mixtures along with modest enhancements (10-20%) of other APIs. These findings align with the performance of S-MGCs using a % GO normalized qₘ, as illustrated in FIGS. 8A-8B.

The adsorption of organic compounds on CGB is a combination of multiple mechanisms, primarily π-π electron-donor-acceptor interaction, which occurs between the electron-rich/electron-deficient regions and polar functional groups of polyaromatic compounds with the CGB surface. Additional mechanisms, such as hydrogen bonding (between hydrogen atoms and electronegative atoms) and hydrophobic interactions (between nonpolar molecules in water), also contribute to the overall organic removal. Hence, APIs characterized by more atomic rings, a greater number of electron-donating/withdrawing substitutions, and a hydrophobic nature could exhibit higher adsorption on the graphene oxide surface compared to other APIs. This was observed both in the context of the single-component and multiple-component systems (FIGS. 7B-7C). For instance, VAL (3 aromatic rings, n-Octanol/Water Partition Coefficient log k_{ow}=5.85, and highly hydrophobic) and DIC (featuring 2 aromatic rings, along with multiple chloro- and amine-functional groups, log K_{ow}=3.97, also hydrophobic) consistently demonstrated superior adsorption among the five studied APIs. However, in the scenario of a multiple-component system (FIG. 7C), these two prominent APIs, VAL and DIC, may competitively interact with other APIs explaining the diminished adsorption of SMZ and CBZ in the multiple-component system when compared to the single-component system, for CGB and S-MGC. Overall, considering the observations in FIGS. 7B-7C, S-MGCs, particularly those with a TiO₂:SiO₂:GO ratio 1:1:1 and 2:0.25:1, outperformed CGB and GAC.

### The Effects of Aqueous Media on the S-MGC Adsorption Performance

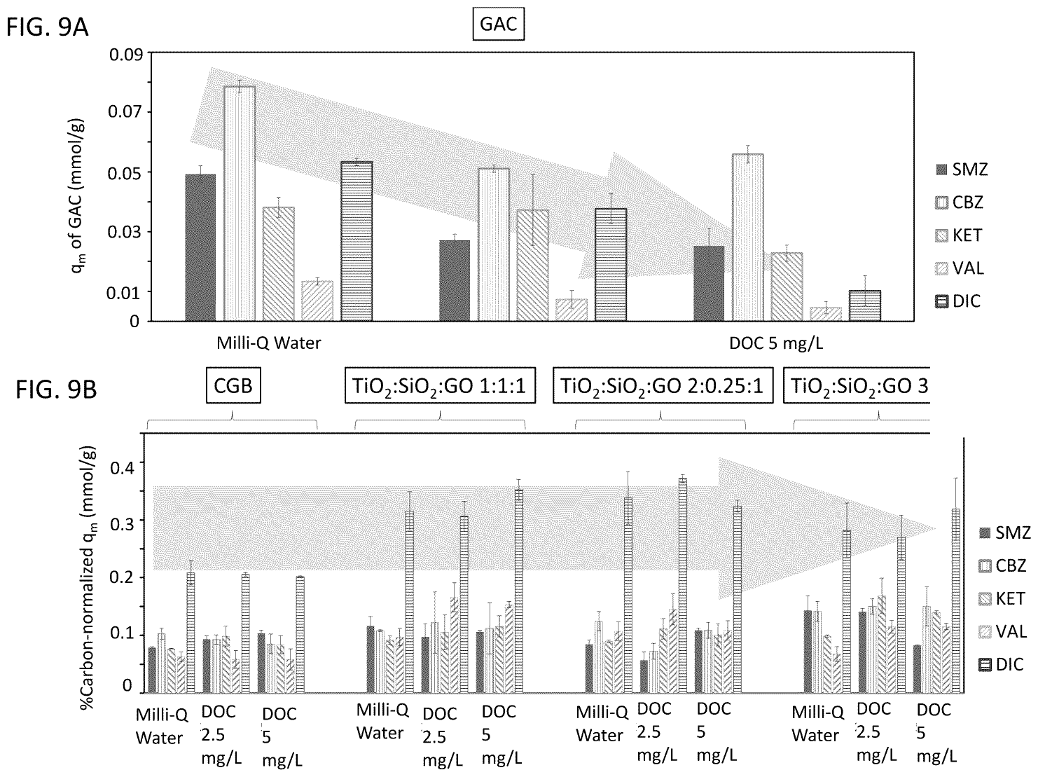

The effect of NOM on the adsorption performance of various adsorbents was investigated by preparing two NOM concentrations (5 mg/L and 10 mg/L SRFA), which are equivalent to DOC levels of 2.5 mg/L and 5 mg/L, typical DOC levels in surface waters. In the case of GAC (as shown in FIG. 9A), adsorption capacity across all the APIs decreased as DOC levels increased, confirming that GAC adsorption was diminished in the presence of NOM. This was attributed to the fact that most of the adsorptive area of GAC was concentrated within its micropores (pore size distribution provided in U.S. provisional application 63/656,138), and the diffusion of APIs to and through these micropores was hindered by NOM. Furthermore, NOM may competitively adsorb on the GAC surface, displacing APIs and further reducing GAC's performance. Conversely, CGB and S-MGCs display stable adsorption performance across the DOC levels, as illustrated in FIG. 9B. The adsorption capacity remained within a 10-15% variation. This stability can be attributed to the greater proportion of mesopores and macropores in CGBs and S-MGCs. Their smaller particle size compared to GAC resulted in shorter diffusion lengths within the micro/mesopore network, allowing for more rapid diffusion of APIs. Moreover, NOM exhibited weaker adsorption on CGBs and S-MGCs, as fulvic acids present in NOM are more aliphatic and less favorably adsorb compared to aromatic APIs. Additionally, NOM has a lesser impact on blocking the micropore network of CGB and S-MGCs, allowing APIs to access more adsorptive surface area.

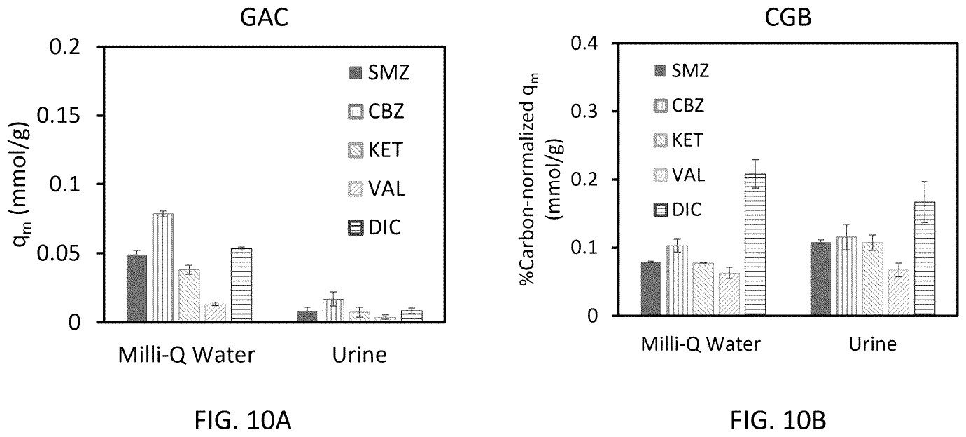

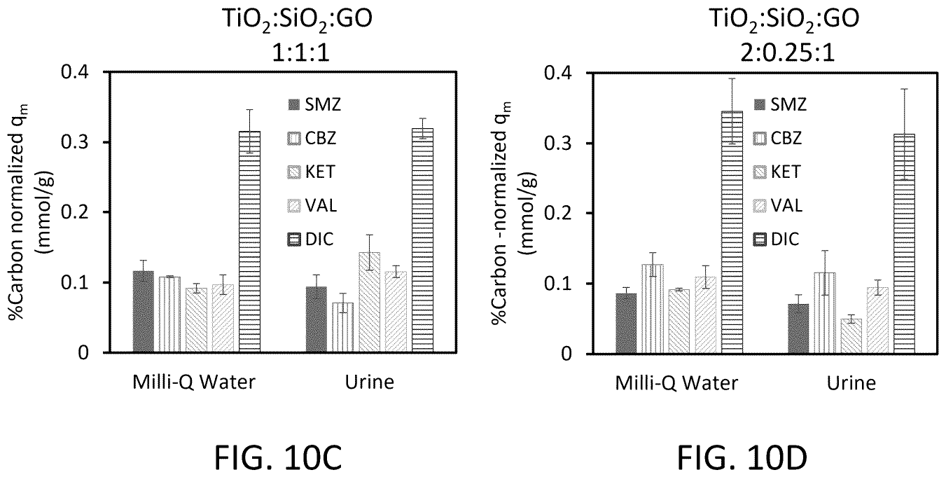

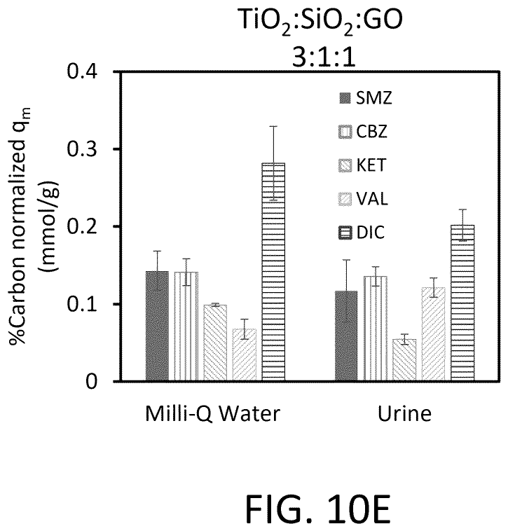

The adsorption of various adsorbents in another complex medium, artificial urine, was also studied (shown in FIGS. 10A-10E). Since 75% of APIs and their metabolites in municipal wastewater are excreted in urine (Clark et al., 2021), API removal at the point of release before it merges with other effluent streams offers application of source separation treatment. In FIG. 10A, the adsorption performance of GAC was significantly hindered for all 5 APIs in the urine environment; qₘ was reduced 70-80% compared to the Milli-Q environment. This phenomenon has been previously reported (Mcdonough et al. 2020, Nature Communications, 11 (1); Almuntashiri et al. 2022, J. Water Process Eng., 45, 102480; Köpping et al., 2020) and explained by the interference of organic compounds (e.g., urea) and high concentrations of ions (e.g. H₂PO₄⁻/HPO₄²⁻) which can disrupt GAC's ability to target adsorb organic compounds (Mcdonough et al., 2020; Almuntashiri, et al., 2022; Köpping et al., 2020). In comparison, CGB and S-MGC remained relatively stable in the artificial urine environment (qₘ varied 20-30%, see FIGS. 10B-10E). This adsorptive stability may be explained by two key factors. Firstly, the non-aromatic structure of urea renders it less competitive compared to aromatic APIs in the adsorption process of S-MGCs. Secondly, at pH>6.5, the surfaces of CGBs and S-MGCs are negatively charged (confirmed by the Zeta potential analysis shown in U.S. provisional application 63/656,138) due to the presence of epoxy functional groups on CGBs/MGCs and hydroxyl functional groups on the metal oxides. This negatively charged surface may mitigate interference from H₂PO₄/HPO₄²⁻ ions.

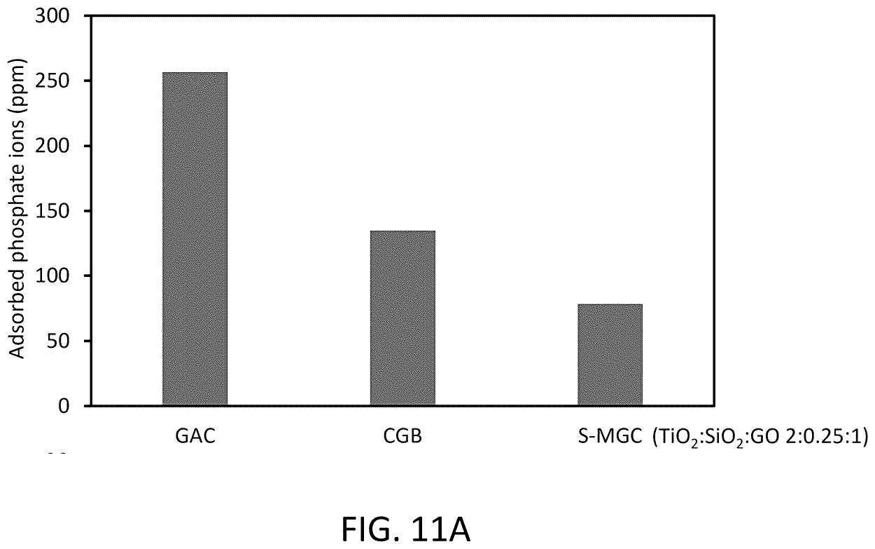

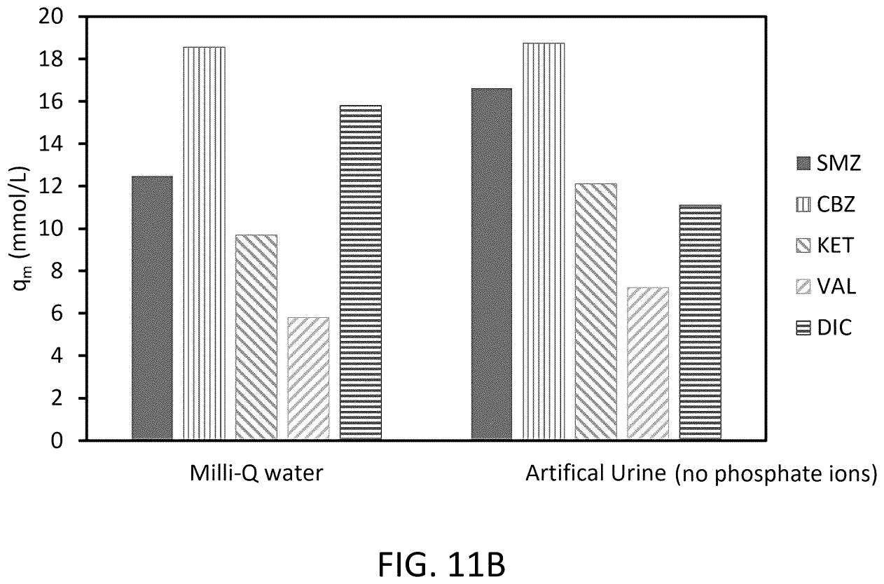

Furthermore, the inference of H₂PO₄/HPO₄²⁻ ions on adsorption was validated by GAC, CGB, and S-MGCs (as shown in FIG. 11A). GAC exhibited the highest level of phosphate ion adsorption among all three adsorbents. In another adsorption experiment conducted in artificial urine with no addition of phosphate (FIG. 11B), GAC exhibited no suppression in its adsorption performance and its performance was comparable to its adsorption behavior in Milli-Q water. This suggests that the presence of phosphate ions in the artificial urine significantly suppressed API sorption on GAC.

### Photodegradation Ability of S-MGCs in APIs

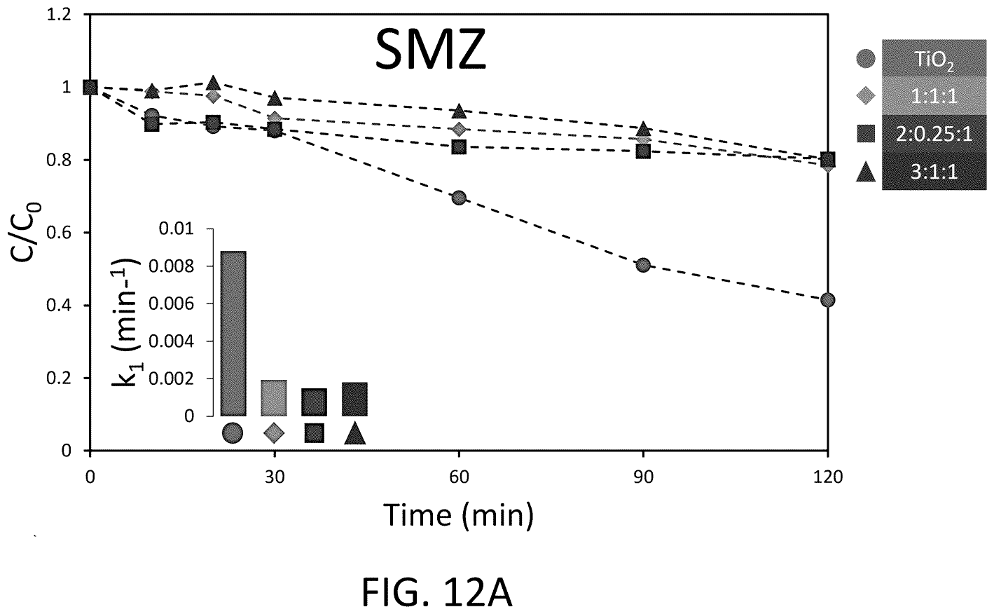

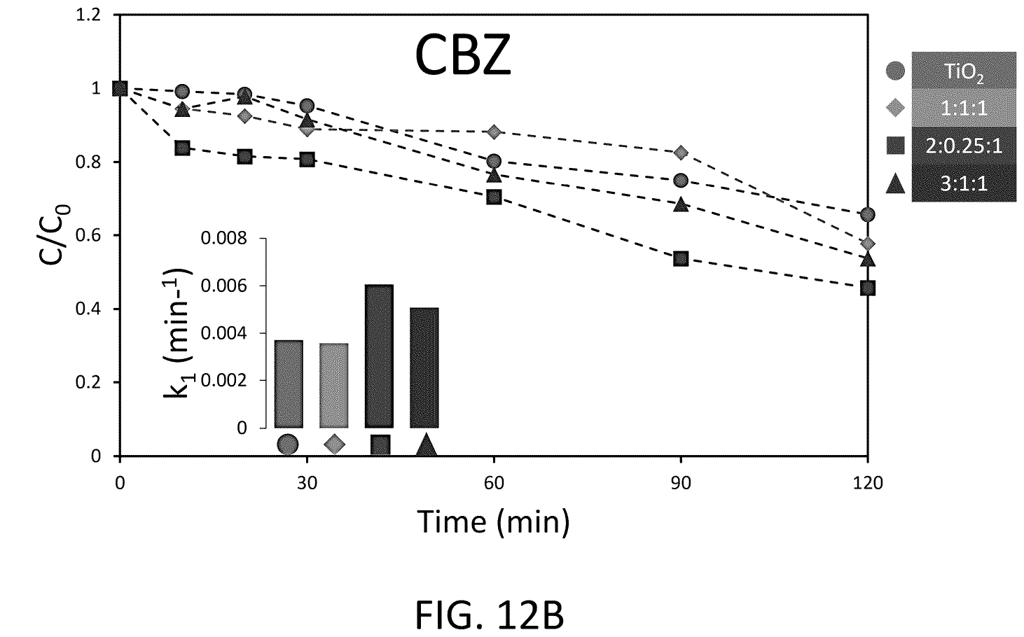

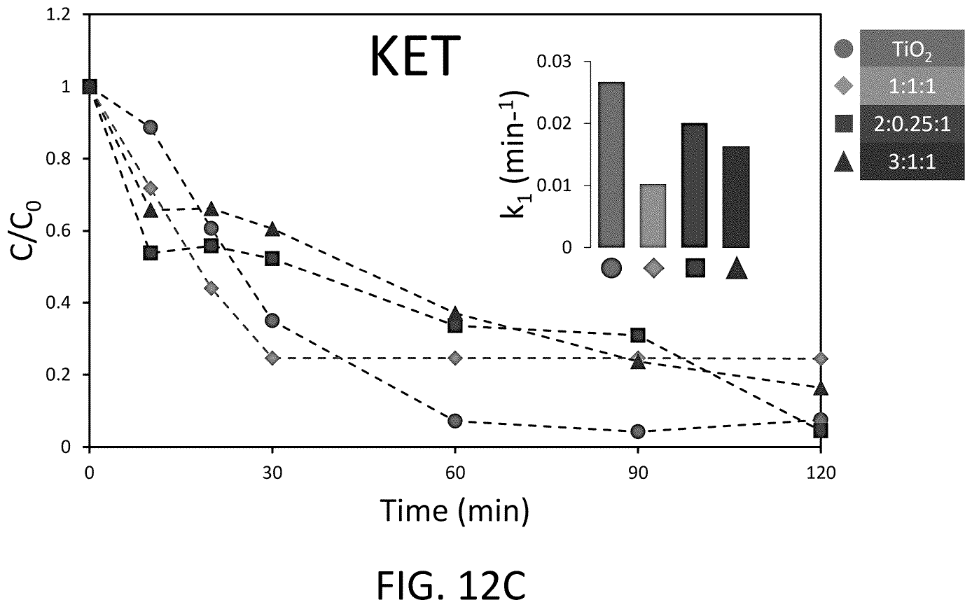

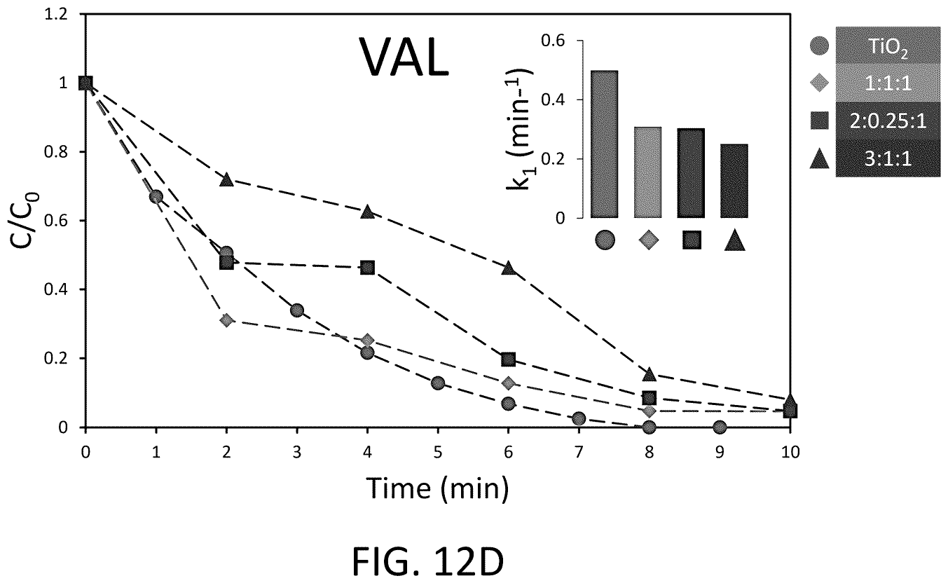

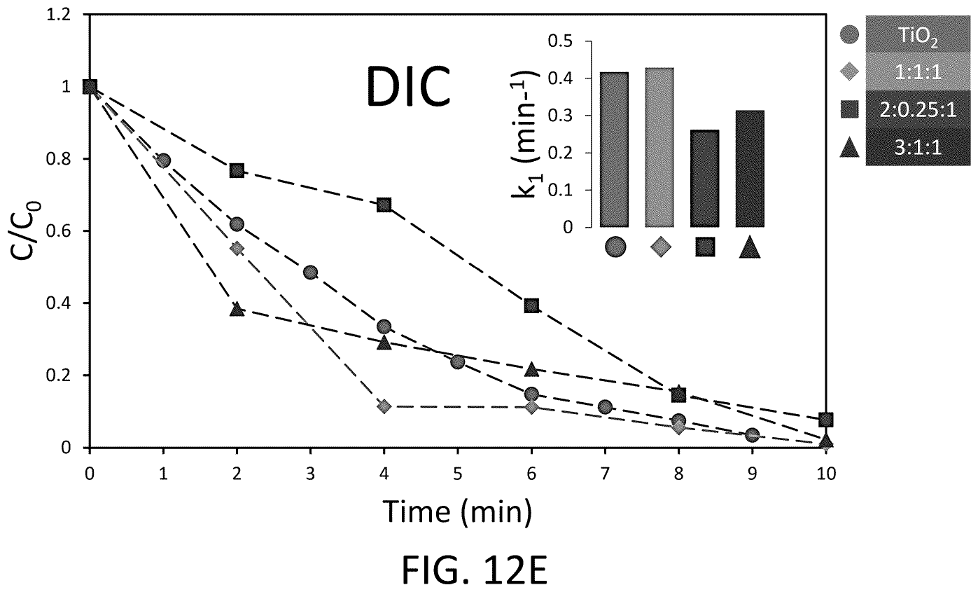

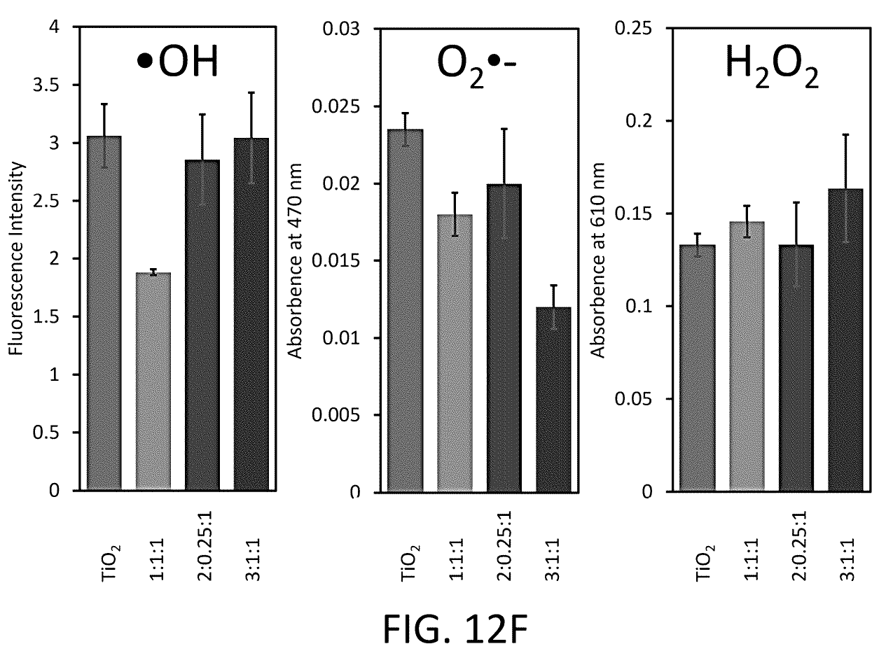

The photodegradation decay curves of S-MGCs and TiO₂ and calculated pseudo-first-order reaction constant k₁ in the presence of the API mixture under light are illustrated in FIGS. 12A-12E. All the S-MGCs and TiO₂ were capable of photodegrading the APIs, although the rates and extent of decay depended on the particular compound. VAL and DIC generally showed faster degradation rates compared to SMZ, CBZ, and KET. Comparing the performance of S-MGCs to TiO₂, TiO₂ outperformed S-MGCs for SMZ/KET/VAL and had similar photodegradation rates in CBZ/DIC. The ROS yields of S-MGCs were also measured and compared to TiO₂ (FIG. 12F). TiO₂ exhibited similar rates of hydroxyl radical (·OH) and hydrogen peroxide (H₂O₂) and a slightly better superoxide anion (O₂·−) generation compared to S-MGCs. Overall, it was concluded that TiO₂ contained in the SMGC composite retained the ROS generation capacity of suspended TiO₂ and was capable of degrading APIs under light illumination.

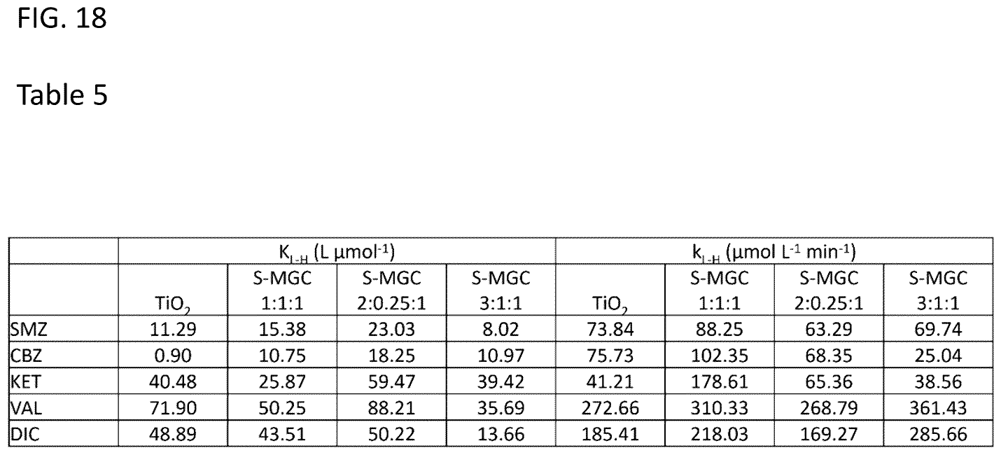

The L-H model was employed to study the adsorption and photodegradation processes of TiO₂ and the three S-MGCs. This model describes the surface reactions between sorbed pharmaceutical molecules and bound ROS, which can either be generated at or transferred to the GO surface (Du et al., 2009). Table 5 in FIG. 18 provides the adsorption constant (K_{L-H}) and the reaction constant (K_{L-H}) of the materials. S-MGC with a TiO₂:SiO₂:GO ratio of 2:0.25:1 displayed superior adsorption performance (larger K_{L-H} values) for all APIs compared to TiO₂ and other S-MGCs. (Calculated Langmuir-Hinshelwood (L-H) model constants (a) K_{L-H} and (b) k_{L-H} for TiO₂ and three S-MGCs are provided in U.S. provisional application No. 63/656,138.) Additionally, the S-MGC with a TiO₂:SiO₂:GO ratio of 1:1:1 showed superior reaction performance (larger k_{L-H} values) in the case of SMZ, CBZ, and KET, while the S-MGC with a TiO₂:SiO₂:GO ratio of 3:1:1 demonstrated superior reaction performance in the case of VAL and DIC (Table 5). The S-MGC with a TiO₂:SiO₂:GO ratio of 2:0.25:1 also exhibited a reasonable photodegradation performance rate, similar to TiO₂.

Overall, the results from the L-H model indicate that S-MGCs significantly outperformed TiO₂ in terms of adsorbing and degrading APIs. This enhanced performance was attributed to the GO adsorption in the nanocomposite, which facilitated surface mediated photo-oxidation and enhanced the ROS generation rate for the degradation of APIs (Fu and Gray, 2021). Based on the result discussed above, two S-MGCs with TiO₂:SiO₂:GO ratios of 1:1:1 and 2:0.25:1 were selected for further investigation in fixed-bed column experiments.

### The Fixed-Bed Column Tests

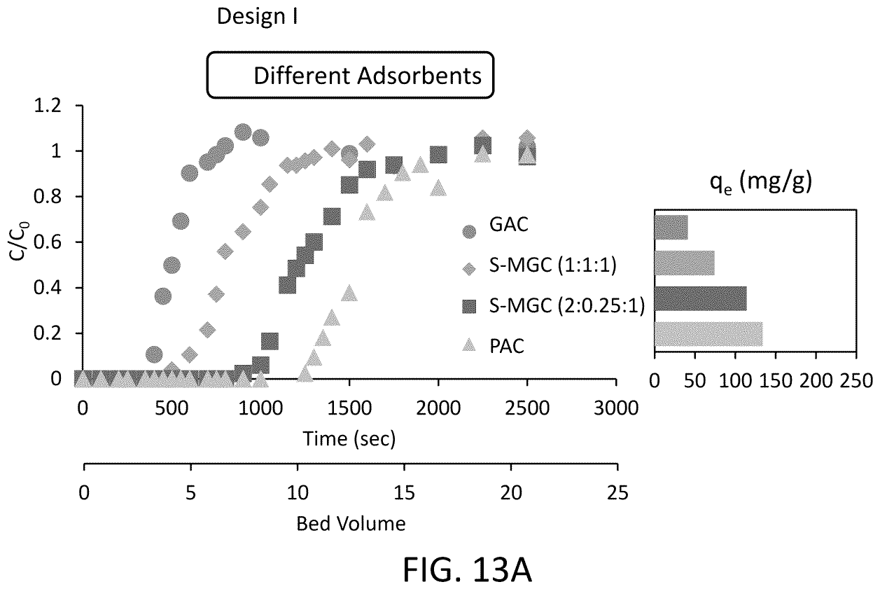

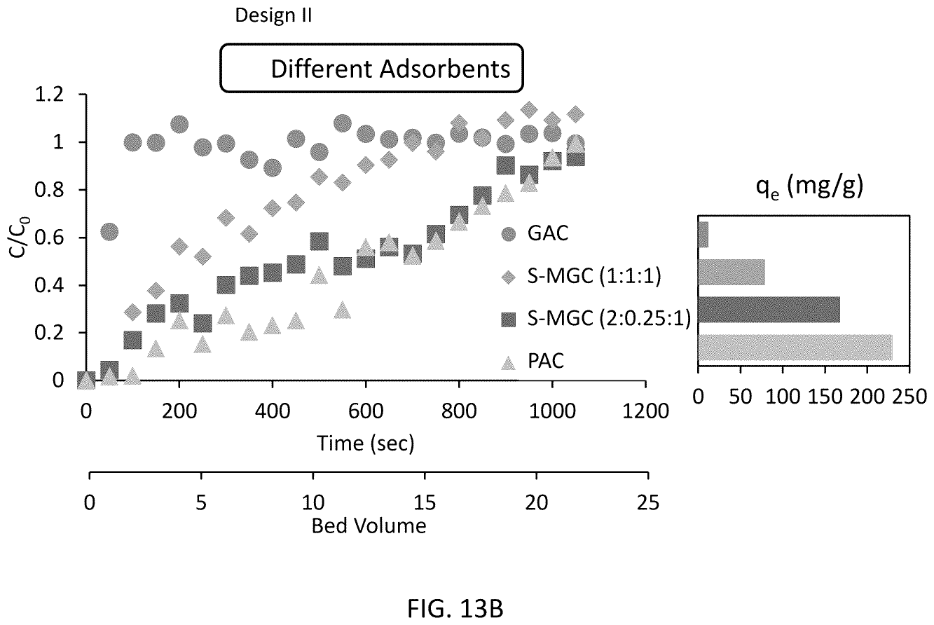

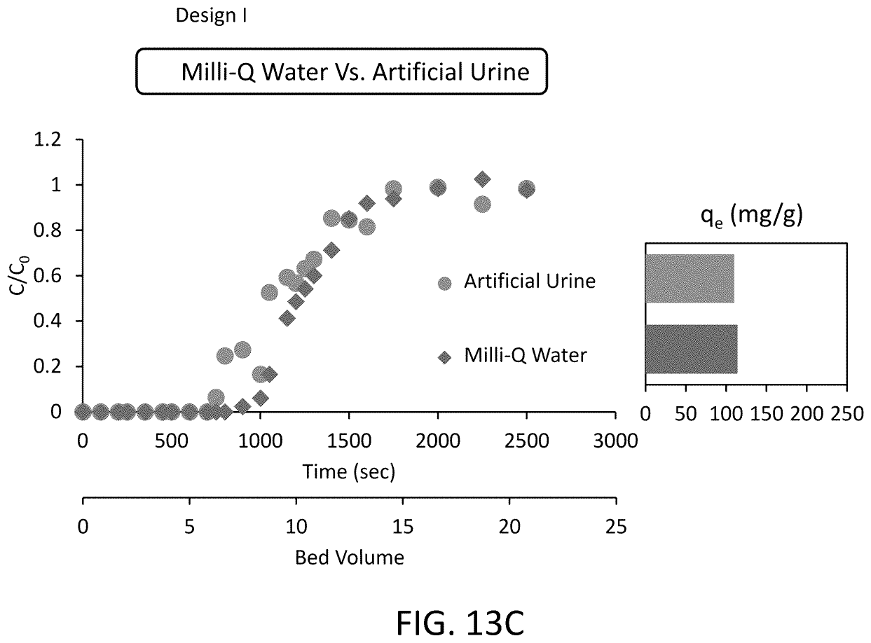

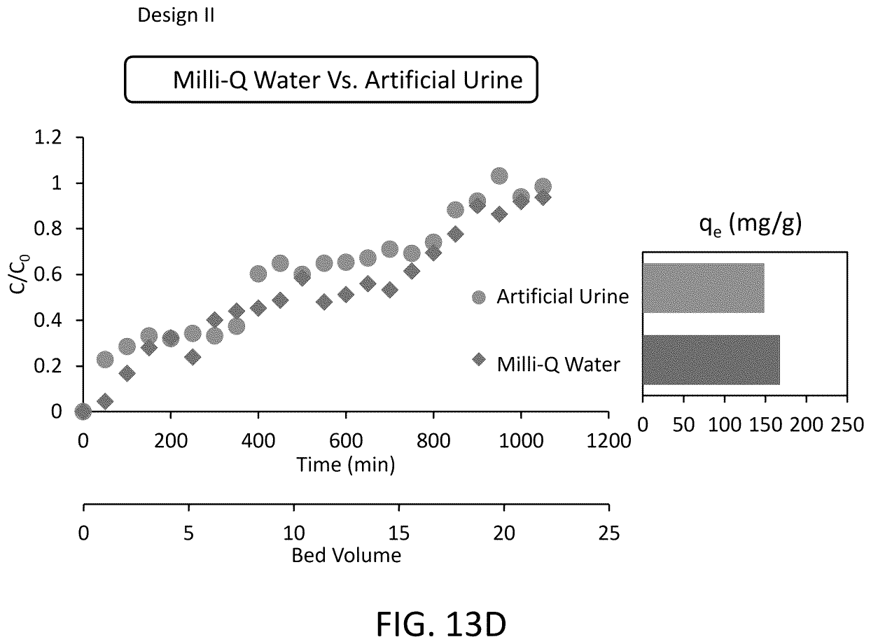

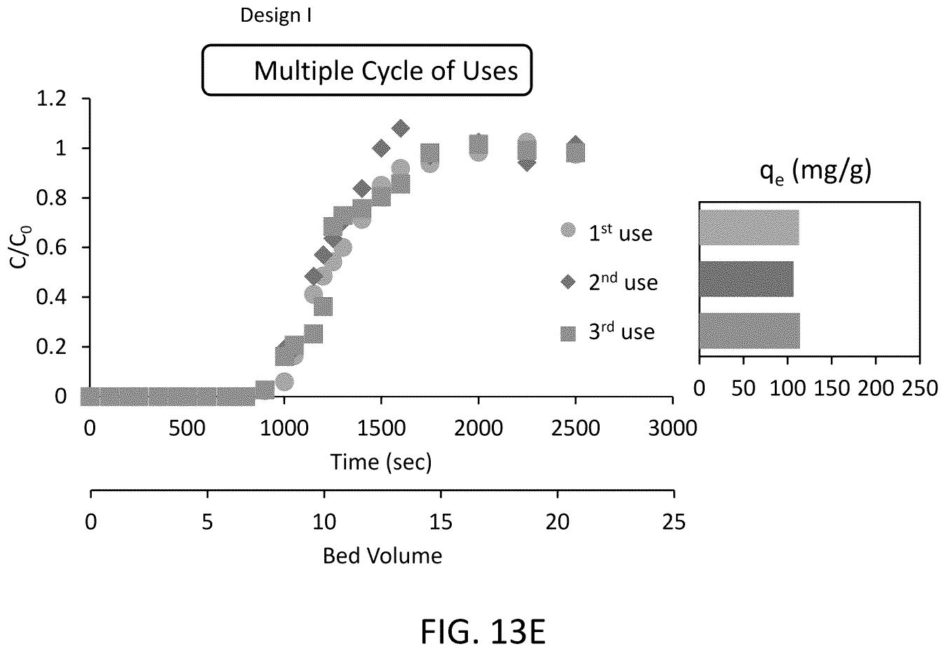

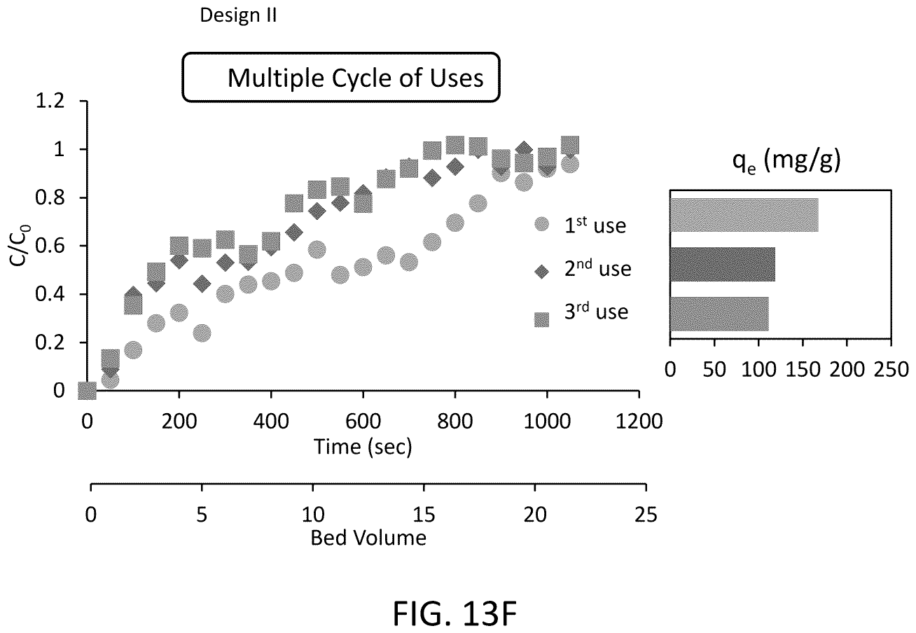

FIGS. 13A-13F provide a summary of the breakthrough curves for various adsorbents (GAC, PAC, two S-MGCs) including S-MGCs in different water environments and across multiple cycles of S-MGC use, using CBZ as the model API. Calculated equilibrium adsorption capacity, qₑ, is also presented (more details summarized in Table 4 in FIG. 17). Results from a control experiment with no adsorbent, demonstrating that the column materials alone had negligible API removal are provided in U.S. provisional application No. 63/656,138. Potential metal oxide or adsorbent residues were also checked for in the initial and final samples of two column experiments and no nanomaterials were detected.

Comparing different adsorbents in both column designs (FIGS. 13A-13B), it was evident that both S-MGCs outperformed GAC, exhibiting 2.5 times larger qₑ in Design I and 13 times larger qₑ in Design II, but the performance of S-MGCs was slightly worse than PAC, with 20-35% smaller qₑ values. This was attributed to the hindered performance of GAC, which resulted from the slow diffusion rates of API molecules to and through the micropore network of GAC (Piai et al. 2019, Water Res, 162, 518-527). In contrast, PAC's smaller particle size allowed for faster API diffusion. The combination of micropores, mesopores, and macropores in the S-MGC structure facilitated an intermediate API adsorption process between the two extremes.

Furthermore, the performance of both S-MGCs (TiO₂:SiO₂:GO 2:0.25:1 and 1:1:1 was stable in the artificial urine, with qₑ varying only 5-10% between Milli-Q water and artificial urine. This stability aligned with the consistent performance of S-MGCs observed in the batch experiments (FIGS. 10C-10D), highlighting that S-MGCs were minimally affected by the non-target ions and organics in artificial urine.

The regeneration of S-MGCs was studied through three adsorption cycles, with regeneration procedures conducted after the first two cycles. For S-MGCs (TiO₂:SiO₂:GO 2:0.25:1 in FIG. 13E-13F), complete regeneration was observed, with similar qₑ values in all three cycles in Design I. However, in Design II, there was a slight reduction between the first cycle and the second/third cycles, resulting in a 30% decrease in qₑ. A similar complete regeneration was observed for the other S-MGC (TiO₂:SiO₂:GO 1:1:1) in Design I and II. In contrast, although PAC exhibited better performance than the two S-MGCs in the first cycle of use, a significant decrease in performance was observed in the second use due to the lack of regeneration ability of PAC under light illumination.

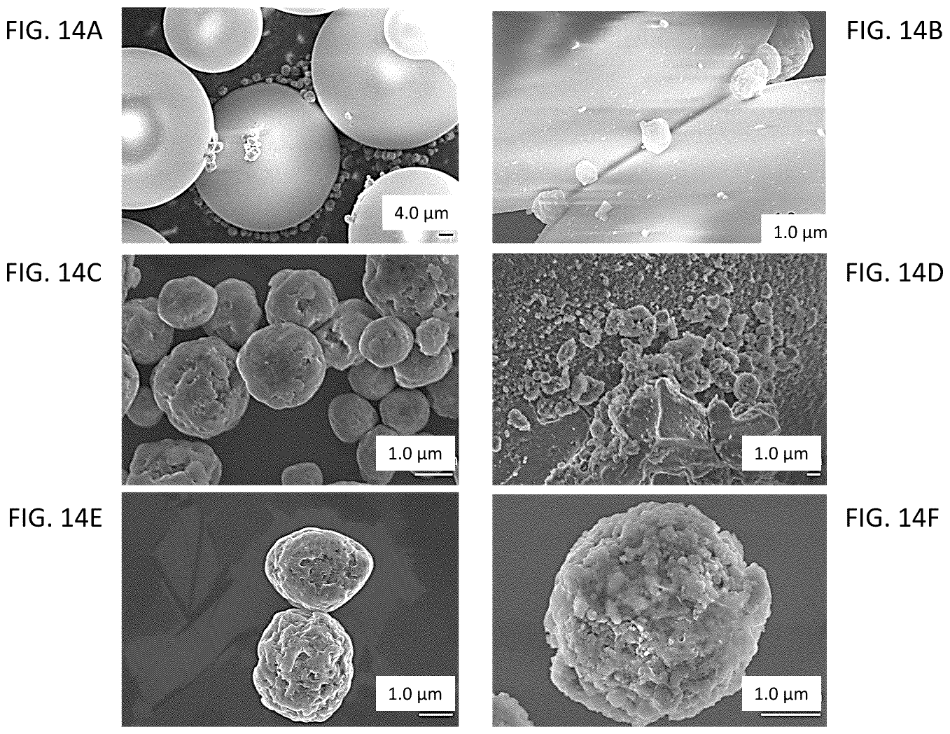

The structural stability of S-MGCs during multiple uses was also evaluated by SEM. In most cases, S-MGC particles retained a stable spherical structure before (FIGS. 14A-14B) and after three cycles of use (FIGS. 14C-14E). However, in some instances, the initially encapsulated metal oxides were observed on the surface of S-MGC (FIG. 14F), indicating a possible structural change in S-MGCs. In one extreme case in Design I, large aggregates of S-MGC were observed on the glass bead surface (FIG. 14D). It is proposed that the quartz beads may function as a “grinder”, damaging the structure of S-MGCs when they are agitated during regeneration.

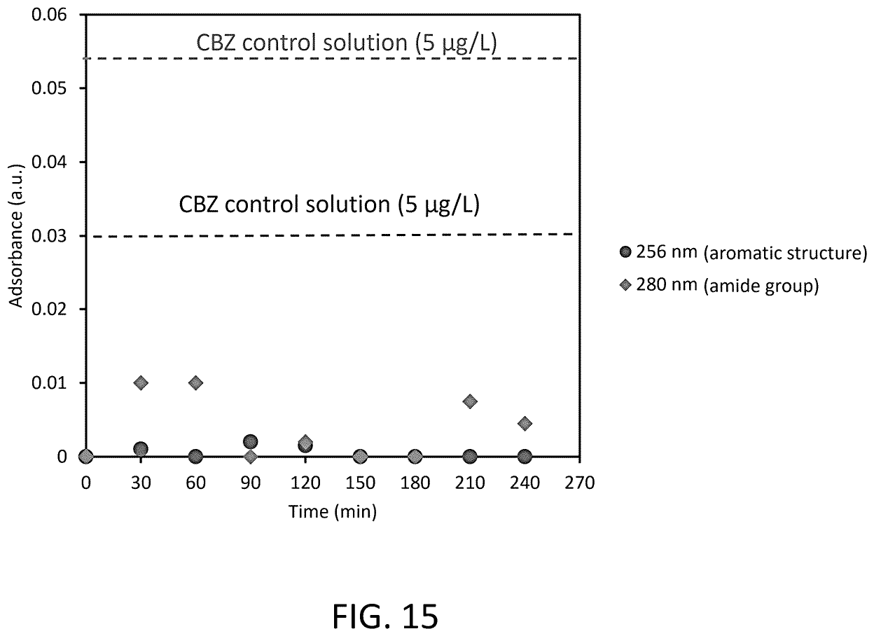

Finally, the decomposition of the CBZ aromatic structure during regeneration was evaluated through UV spectrum measurements at two wavelengths (265 nm representing aromatic rings and 280 nm representing amide groups) in Design II experiments. The results (FIG. 15) revealed no obvious detection of aromatic rings and amide groups during 4 hours of light illumination, demonstrating decomposition of CBZ aromatic structure and potential mineralization of CBZ in the liquid phase during regeneration.

### Additional Experimental Details

### Materials and Reagents

Methylene blue was purchased from Merck & Co. Inc. (United States Pharmacopeia Reference Standard). Sulfamethoxazole was purchased from Dot Scientific (purity>98%). Valsartan was purchased from TCI (purity>98%). Carbamazepine (purity>98%), Ketoprofen (purity≥98%), and Diclofenac sodium (purity>98%) were purchased from Sigma-Aldrich. Formic acid (EMD™ 98%) and ammonia hydroxide (Honeywell 5.0M solution) were used to adjust the pH, as previously used (Fu et al. 2021, Carbon, 183, 958-969; Fu and Gray 2021, Nanomaterials, 11, 2087; Fu et al. 2023, J. Hazard. Mater., 444, 130340). Titanium dioxide (AEROXIDE P25, >99.5% trace metal basis) was provided by Evonik Industries (Germany). Silicon oxide (>99.5% trace metal basis) was purchased from Aldrich. GO aqueous solution (10 mg/mL) was manufactured by Merk™ (Lot number: 300-43C). Two activated carbon representatives were utilized for comparison: GAC (NORIT® GAC 1240, Thomas Scientific and PAC (Darco G60, Sigma Aldrich). The physical properties of metal oxides and activated carbon materials are summarized in Table 6. Milli-Q water was employed as the background medium, obtained via a Milli-Q RG QPAK 1 column, ensuring a standardized ultrapure water resistivity level of 18.2 MΩ-cm at 25° C. Suwannee River fulvic acid (SRFA, code 2S101F), used to model the effect of NOM, was obtained from the International Humic Substance Society (Denver, CO, USA).

TABLE 6
The physical properties of TiO₂, SiO₂, GAC, and PAC

| | | | | | Specific |
|---|---|---|---|---|---|
| | | Nominal | | Bulk | Surface |
| | | Particle | | Density | Area |
| | Brand | Size* | | (g/mL) | (m²/g) |
| TiO₂ | AEROXIDE | Average | | 4.3 | 65.32 |
| | P25, >99.5% trace | 25.4 nm; | | | |
| | metal basis, Evonik | 15-40 nm | | | |
| | Industries (Germany) | | | | |
| SiO₂ | >99.5% trace metal | 10-20 | nm | 2.3 | 444.58 |
| | basis, Aldrich | | | | |
| GAC | NORIT(R) GAC 1240, | 0.42-1.68 | mm | 0.5 | 1,069.67 |
| | Thermo Fisher | | | | |
| PAC | Darco G60, Sigma | 0.04-0.15 | mm | 1.8 | 979.52 |
| | Aldrich | | | | |

*The nominal particle sizes of metal oxide are provided by the manufacturers and previous studies.

### S-MGC Synthesis and Characterization

S-MGC was made using the nano-spray drying method. Initially, varying amounts of TiO₂ and SiO₂ were added in 140 mL Milli-Q water and sonicated for 30 minutes; then 60 mL GO stock solution (1 mg/mL) was added and continuously sonicated for another 30 minutes to ensure a well-suspended mixture. Different amounts of TiO₂ and SiO₂ particles (corresponding to different TiO₂:SiO₂:GO weight ratios) were summarized in Table 7. It was determined that a final concentration of 0.3 mg/mL GO in the 200 mL final suspension avoids GO stacking during the nano-spray synthesis. The pH of the mixture was adjusted to 6.5 and sprayed at 95° C. using the Buchi B-90 nano-spray dryer (nozzle size 7 μm, part #051749) while continuously stirring the suspension. The resulting particles were collected in the particle collection chamber at the bottom of the instrument. These collected particles were then annealed at 150° C. for 60 minutes to eliminate moisture and surface impurities. CGB (GO only) was synthesized via the same procedure without the addition of SiO₂ and TiO₂.

TABLE 7
The TiO₂:SiO₂:GO weight compositions of S-MGCs, their abbreviations,
and added amounts during S-MGC synthesis.

| | | Added Amount | | | | |
|---|---|---|---|---|---|---|
| | | | | | | GO |
| Sample | TiO₂:SiO₂:GO | | | | | Stock Solution |
| Name | ratio | TiO₂ | | SiO₂ | | (1 mg/mL) |
| CGB | GO only | 0 | mg | 0 | mg | 60 mL |
| A | 0.25:1:1 | 15 | mg | 60 | mg | 60 mL |
| B | 0.5:1:1 | 30 | mg | 60 | mg | 60 mL |
| C | 1:0:1 | 60 | mg | 0 | mg | 60 mL |
| D | 1:0.25:1 | 60 | mg | 15 | mg | 60 mL |
| E | 1:0.5:1 | 60 | mg | 30 | mg | 60 mL |
| F | 1:1:1 | 60 | mg | 60 | mg | 60 mL |
| G | 2:0:1 | 120 | mg | 0 | mg | 60 mL |
| H | 2:0.25:1 | 120 | mg | 15 | mg | 60 mL |
| I | 2:0.5:1 | 120 | mg | 30 | mg | 60 mL |
| J | 2:1:1 | 120 | mg | 60 | mg | 60 mL |
| K | 3:0:1 | 180 | mg | 0 | mg | 60 mL |
| L | 3:0.25:1 | 180 | mg | 15 | mg | 60 mL |
| M | 3:0.5:1 | 180 | mg | 30 | mg | 60 mL |
| N | 3:1:1 | 180 | mg | 60 | mg | 60 mL |
| O | 4:0:1 | 240 | mg | 0 | mg | 60 mL |
| P | 4:0.25:1 | 240 | mg | 15 | mg | 60 mL |
| Q | 4:0.5:1 | 240 | mg | 30 | mg | 60 mL |

S-MGCs were characterized by a variety of techniques. SEM images were acquired with a Hitachi SU8030 and EDS analysis was conducted via AZtec X-max 80 SDD EDS detector. The particle size analysis was calculated based on 30 particles in the SEM images. X-ray Photoelectron Spectroscopy (XPS) was carried out on the Thermo Scientific ESCALAB 250Xi. FTIR spectroscopy measurements were made with a Nexus 870 spectrometer (Absorbance mode, 4 cm⁻¹ resolution, 4000-400 cm⁻¹ wavelength range, 64 scans). Nitrogen adsorption and desorption analyses were conducted with a Micromeritics 3Flex Surface Area Analyzer and the related calculation on specific surface area and pore size distribution was performed on the software MicroActive™.

Determination of the Optimized TiO₂:SiO₂:GO Ratio in S-MGC

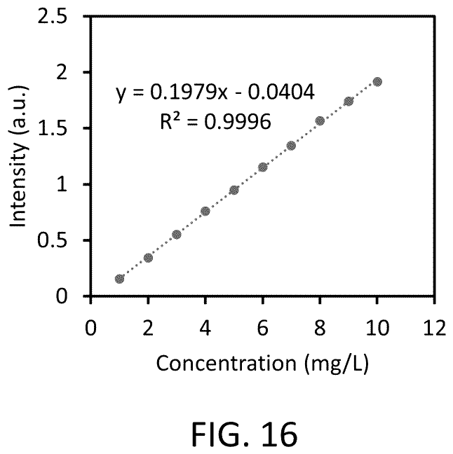

The optimal TiO₂:SiO₂:GO ratio in S-MGC was determined based on their adsorption and photodegradation performance using MB. In the adsorption experiments, the initial MB concentration was varied from 50 to 200 mg/L and pH was adjusted to 7.5±0.1. The prepared solutions were dispensed into 50 mL Teflon-lined screw-top glass vials and the adsorbent (CGB and different S-MGCs) was then added at an adsorbent dosage 0.1 mg/mL. All sample vials were continuously shaken on a platform shaker (Model Innova™ 2100) at 200 rpm and room temperature in the absence of light for 24 hours to reach equilibrium. After 24 hours of shaking, the vials were sampled via a syringe (BD 1 mL TB Syringe) and 0.2 μm PTFE syringe filter (Whatman™). MB concentration quantification was performed based on a linear calibration curve, which relied on the absorbance at 665 nm within a concentration range of 1 to 10 mg/L, using UV-Vis spectra from Eppendorf BioSpectrometer® Basic (the calibration line is shown in FIG. 16). The Langmuir isotherm model was employed to fit the experimental data and the Langmuir adsorption capacity, qₘ, was normalized by the % GO (by weight), which can be represented as:

$$\% GO normalized {q}_{m} = \frac{Adsorded MB [ mg ]}{A d s o rbent weight [ mg ] \times \% GO} = \frac{{q}_{m}}{\% GO}$$

Photodegradation experiments on MB were conducted through batch experiments in Milli-Q water. A 50 mL MB solution at different initial concentrations (50 mg/L) was prepared in a 100 ml beaker and the pH of the solution was adjusted to 7.5±0.1. Ten grams of the catalyst (0.2 mg/mL of CGB, S-MGC, or TiO₂) was then added, and the suspension was stirred at 300 rpm in the dark for 30 minutes to reach the adsorption equilibrium. Illumination was supplied by a Newport 1000 W Ozone Free xenon arc lamp (model #6271 Ozone Free) with power output at 1000 W. After the light was switched on, at regular intervals (every hour), the suspension was sampled via a syringe (BD 1 mL TB Syringe) and 0.2 μm PTFE syringe filter (Whatman™). The concentration of MB was evaluated via UV-Vis spectra, as in the adsorption experiments, and the pseudo-first-order reaction model was employed to fit the experimental data.

### Reactive Oxygen Species (ROS) Measurement

ROS was quantified using the appropriate absorbance & fluorescence molecular probes. All tests were performed in 96-well microtiter plates, and molecular probes were detected using the Gemini EM fluorescence microplate reader (model #BZBLKU765). Illumination was provided by a 1000 W Xenon lamp. Three replicates were performed for each measurement. The control experiments were performed in the absence of a catalyst under the same irradiation conditions. First, hydroxyl radical (·OH) production was assessed after reaction with coumarin-3-carboxylic acid (3-CCA) to form fluorescein. (Náfrádi, M. et al. 2020, Radiation Physics and Chemistry, 170, 108610.) Ten μL of 100 μM 3-CCA, 10 μL of catalyst mixture, and 80 μL of purified water were added to each well in a microtiter plate. After 30 minutes of irradiation, the pH of the mixture was adjusted to 9.5. The reaction of 3-CCA and hydroxyl radical produces 7-Hydroxycoumarin-3-carboxylic acid (7-HO-3-CCA). The fluorescence due to the excitation of 7-HO-3-CCA was measured (ex/em=387 nm/447 nm). Second, superoxide anion (O₂·⁻) was determined using 2,3-bis(2-methoxy-4-nitro-5-sulfophenyl)-2H-tetrazolium-5-carboxanilide sodium salt (XTT sodium salt, Sigma-Aldrich). (Zhang, W. et al. 2013, Langmuir, 29 (15), 4647-4651.) Twenty μL of 1 mM XTT, 20 μL of nanoparticle mixtures, and 160 μL of purified water were added to plate wells and then exposed to 1000 W Xenon lamp irradiation for 30 minutes. The reaction of XTT with superoxide anion produces XTT formazan, which was detected by measuring its absorbance at 470 nm. Third, hydrogen peroxide (H₂O₂) production was detected using phenol red. (Pick, E. et al. 1980, Journal of Immunological Methods, 38 (1-2), 161-170.) Ten μL of the catalyst mixture was added to 90 μL of LMW in a well plate and irradiated for 30 minutes. Ten μL of 0.77 M NaOH, 10 μL of 1 g/L phenol red (Sigma-Aldrich), and 10 μL of 0.5 mg/mL horseradish peroxidase (Type II, salt-free powder, Sigma-Aldrich) were then added to each well and mixed thoroughly. The absorbance at 610 nm was measured to detect the oxidation product of phenol red and hydrogen peroxide. The absorbance for the control was due to the red color of the phenol red dye, and changes in absorbance at 610 nm are attributed to the purple color of the reaction product.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. Composite particles comprising:
crumpled graphene oxide balls;
photocatalytically active nanoparticles dispersed within the crumpled graphene oxide balls; and
volume-expanding nanoparticles dispersed within the crumpled graphene oxide balls.

2. The composite particles of claim 1, wherein the volume-expanding nanoparticles comprise inorganic oxide particles.

3. The composite particles of claim 1, wherein the volume-expanding nanoparticles comprise SiO₂ particles.

4. The composite particles of claim 1, wherein the photocatalytically active particles comprise metal oxide particles.

5. The composite particles of claim 1, wherein the photocatalytically active nanoparticles comprise TiO₂ particles.

6. The composite particles of claim 5, wherein the volume-expanding nanoparticles comprise SiO₂ particles.

7. The composite particles of claim 6, wherein the mass ratio of the TiO₂ particles to the crumpled graphene oxide balls is 1:1 or higher and the mass ratio of the SiO₂ particles to the crumpled graphene oxide balls is 1:1 or lower.

8. The composite particles of claim 1, wherein the mass ratio of the photocatalytically active nanoparticles to the crumpled graphene oxide balls is 1:1 or higher.

9. The composite particles of claim 1, wherein the mass ratio of the volume-expanding nanoparticles to the crumpled graphene oxide balls is 1:1 or lower.

10. The composite particles of claim 1, wherein the composite particles have an average particle size in the range from 1 μm to 3 μm.

11. The composite particles of claim 10, wherein the photocatalytically active nanoparticles have an average particle size of less than 50 nm and the volume-expanding nanoparticles have an average particle size of less than 50 nm.

12. A method of removing one or more organic compounds from water or an aqueous solution, the method comprising:
contacting composite particles with the water or aqueous solution, the composite particles comprising crumpled graphene oxide balls, photocatalytically active nanoparticles dispersed within the crumpled graphene oxide balls, and volume-expanding nanoparticles dispersed within the crumpled graphene oxide balls, whereby the one or more organic compounds adsorb to the crumpled graphene oxide balls; and
illuminating the photocatalytically active nanoparticles dispersed within the crumpled graphene oxide balls with radiation to generate reactive oxygen species that induce photodegradation of the one or more adsorbed organic compounds.

13. The method of claim 12, wherein the volume-expanding nanoparticles comprise inorganic oxide particles.

14. The method of claim 12, wherein the photocatalytically active nanoparticles comprise metal oxide particles.

15. The method of claim 12, wherein the organic compounds comprise aromatic organic compounds.

16. The method of claim 12, wherein the organic compounds comprise sulfamethoxazole (SMZ), carbamazepine (CBZ), ketoprofen (KET), valsartan (VAL), diclofenac (DIC), a sulfonamide, caffeine, sucralose, a bisphenol, metolachlor, oxybenzone, or a combination of two or more thereof.

17. The method of claim 12, wherein the water or aqueous solution comprises a wastewater from a medical facility or a pharmaceutical manufacturing plant.

18. The method of claim 12, wherein the composite particles are contained within a column and the water or aqueous solution is passed through the column.

19. The method of claim 12, further comprising rinsing the composite particles with water or an aqueous solution to remove products of the degradation of the organic compounds.

20. The method of claim 12, wherein the radiation comprises ultraviolet radiation.
